(19) United States
(12) Patent Application Publication
(10) Pub. No.: US 2009/0051858 A1
(43) Pub. Date: Feb. 26, 2009

(54) OPTICAL COMPENSATION FILM, METHOD OF PRODUCING THE SAME, AND POLARIZING PLATE AND LIQUID CRYSTAL DISPLAY DEVICE USING THE SAME

(75) Inventors: Kazuhiro Nakamura, Minami-ashigara-shi (JP); Tomohiko Yamaguchi, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 12/195,254

(22) Filed: Aug. 20, 2008

(30) Foreign Application Priority Data
Aug. 20, 2007 (JP) 2007-213600

(51) Int. Cl. G02F 1/1337; G02F 1/1335; B01J 19/08; C08F 2/46

(52) U.S. Cl. 349/96; 349/123; 427/536; 427/521

(57) ABSTRACT

Provided is an optical compensation film comprising a support, an alignment layer, and an optically anisotropic layer formed of a liquid crystal composition in this order, said support being a cyclic polyolefin polymer film having a surface thereof subjected to corona discharge treatment or atmospheric pressure plasma treatment, wherein said alignment layer is disposed in contact with said treated surface of said support, said liquid crystal composition comprises a radical polymerization initiator capable of generating a halogen radical or a hydrocarbon radical having atoms other than hydrogen atom of the number equal to or smaller than 8, and said optically anisotropic layer is a layer formed by curing said liquid crystal composition on said alignment layer via polymerization.

### CROSS-REFERENCE TO RELATED APPLICATIONS

This application claims benefit of priority under 35 U.S.C. 119 to Japanese Patent Application No. 2007-213600 filed on Aug. 20, 2007; and the entire contents of the application are incorporated herein by reference.

### BACKGROUND OF THE INVENTION

1. Field of the Invention

The present invention relates to an optical compensation film, a method of producing the same, and a polarizing plate and a liquid crystal display device using the same.

2. Related Art

There have conventionally been proposed a variety of optical compensation films of liquid crystal display devices, comprising a polymer film as a support, and an optically anisotropic layer formed of a liquid crystal composition formed thereon. There have also been proposed, as the optical compensation films further improved in the durability, those comprising a polymer film having a photo-elastic coefficient and moisture permeability adjusted in predetermined ranges as a support (for example, Published Japanese Translations of PCT International Publication No. 2005-520209), with a description that a cyclic polyolefin polymer film may be adoptable as the support.

By the way, an optical compensation film having an optically anisotropic layer formed of a liquid crystal composition is generally produced as follows. An alignment layer is formed on the surface of the polymer film, and then the optically anisotropic layer is formed on the alignment layer by making use of alignment control ability of the alignment layer. Namely, when such optical compensation films are produced, it is general to form an alignment layer between the polymer film, a support, and an optically anisotropic layer. Polymers having relatively large hydrophilicity, such as polyvinyl alcohol, may be used for the alignment layer since they have good adhesiveness with the optically anisotropic layer, film-forming performance at temperatures as low as not causative of damages on the support, and solubility into a solvent for coating not solubilizing the support. And there are not a few a cyclic polyolefin polymer films having relatively large hydrophobicity, and they suffer from poor adhesiveness with such an alignment layer.

Aiming at improving the adhesiveness, there has also been proposed an optical compensation sheet having an adhesiveness improving layer formed between a polymer film and an alignment layer (for example, Japanese Laid-Open Patent Publication No. H7-333433).

### SUMMARY OF THE INVENTION

An object of the present invention to provide an optical compensation film comprising a cyclic polyolefin polymer film as a support, improved in the adhesiveness between the support and an alignment layer, and excellent in durability, and a polarizing plate and a liquid crystal display device using the same.

The means for achieving the object are as follows.

[1] An optical compensation film comprising a support, an alignment layer, and an optically anisotropic layer formed of a liquid crystal composition in this order, said support being a cyclic polyolefin polymer film comprising, as a major ingredient, at least one cyclic polyolefin comprising a repeating unit having a cycloaliphatic ring, and having a surface thereof subjected to corona discharge treatment or atmospheric pressure plasma treatment,

wherein said alignment layer is disposed in contact with said treated surface of said support, said liquid crystal composition comprises a radical polymerization initiator capable of generating a halogen radical or a hydrocarbon radical having atoms other than hydrogen atom of the number equal to or smaller than 8, and said optically anisotropic layer is a layer formed by curing said liquid crystal composition on said alignment layer via polymerization.

[2] The optical compensation film as set forth in [1], wherein swellability of said alignment layer is 1 to 2,

where the swellability represents a ratio of thickness of the swelled alignment layer to thickness of the unswelled alignment layer, the swelled and unswelled thicknesses of the alignment layer correspond to thicknesses of the alignment layer after and before the optical compensation film is immersed in a solvent, which is contained as a major solvent in a coating liquid used for preparing the alignment layer.

[3] The optical compensation film as set forth in [1] or [2], wherein said alignment layer is prepared by curing a curable composition applied to said treated surface of said support with irradiation of light under heat.

[4] The optical compensation film as set forth in any one of [1] to [3], wherein said cyclic polyolefin polymer film comprises, as a major ingredient, at least one cyclic polyolefin comprising a repeating unit having a cycloaliphatic ring having at least one substituent containing a hetero atom.

[5] The optical compensation film as set forth in any one of [1] to [4], wherein said radical polymerization initiator comprises at least one compound represented by formula (1) below:

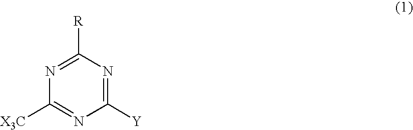

where, X represents a halogen atom; Y represents —CX₃, —NH₂, —NHR′, —NR′₂ or OR′; R′ represents an alkyl group or aryl group; and R represents —CX₃, alkyl group, substituted alkyl group, aryl group, substituted aryl group, or substituted alkenyl group.

[6] The optical compensation film as set forth in any one of [1] to [5], wherein the liquid crystal composition comprises at least one discotic liquid crystal compound.

[7] The optical compensation film as set forth in any one of [1] to [6], wherein the liquid crystal composition comprises at least one rod-like liquid crystal compound.

[8] A polarizing plate comprising a polarizing film and an optical compensation film as set froth in any one of [1] to [7].

[9] A liquid crystal display device comprising at least one polarizing plate as set forth in [8].

[10] The liquid crystal display device as set forth in [9], employing a TN-mode or an OCB-mode.

[11] A method of producing an optical compensation film comprising a support composed of a cyclic polyolefin polymer film, and an alignment layer and an optically anisotropic layer formed of a liquid crystal composition in this order, comprising in a following order:

(1) subjecting a surface of a cyclic polyolefin polymer film comprising, as a major ingredient, at least one cyclic polyolefin comprising a repeating unit having a cycloaliphatic ring, to corona discharge treatment or atmospheric pressure plasma treatment;

(2) forming an alignment layer on the treated surface of said cyclic polyolefin polymer film treated by corona discharge treatment or atmospheric pressure plasma treatment; and

(3) forming an optically anisotropic layer on said alignment layer by curing a liquid crystal composition, comprising a radical polymerization initiator capable of generating a halogen radical or a hydrocarbon radical having atoms other than hydrogen atom of the number equal to or smaller than 8 via polymerization.

[12] The method as set forth in [11], wherein said step (2) is a step of forming an alignment layer by curing a curable composition applied to the surface of said cyclic polyolefin polymer film, of which surface is subjected to corona discharge treatment or atmospheric pressure plasma treatment, with irradiation of light under heat.

[13] The method as set forth in [11], further comprising, prior to said step (2), removing dust from the treated surface of said cyclic polyolefin polymer film treated by corona discharge treatment or atmospheric pressure plasma treatment.

[14] The method as set forth in [11], further comprising, prior to said step (3), removing dust from a rubbed surface of said alignment layer.

[15] The method as set forth in [13] or [14], wherein dust is removed using ultrasonic wave.

### BRIEF DESCRIPTION OF THE DRAWINGS

FIG. 1 is a graph showing wavelength dispersion of Re of optical compensation films 1 and 9 produced in Example 1 and Example 9.

### PREFERRED EMBODIMENT OF THE INVENTION

The invention will be described in detail below. The expression “from a lower value to an upper value” referred herein means that the range intended by the expression includes both the lower value and the upper value.

### [Optical Compensation Film]

The present invention relates to an optical compensation film comprising a support which is a cyclic polyolefin polymer film, an alignment layer, and an optically anisotropic layer formed of a liquid crystal composition, in this order. According to the present invention, the surface of the cyclic polyolefin polymer film, used as the support and having a relatively large hydrophobicity, is subjected to corona discharge treatment or atmospheric pressure plasma treatment, and the alignment layer formed of a material having a relatively large hydrophilicity is formed in contact with thus treated surface. As a consequence, the optical compensation film of the present invention is improved in the adhesiveness between the cyclic polyolefin polymer film as the support and the alignment layer, less causative of failures such as separation at the interface between the support and the alignment layer, and excellent in the durability.

A new problem of separation between the alignment layer and the optically anisotropic layer, which may not have often been discussed before, arose when the cyclic polyolefin polymer film, was adopted as a support, and when alignment layer and the optically anisotropic layer formed of a liquid crystal composition, which have been used for the conventional product, were stacked, even if the separation at the interface between the support and the alignment layer was improved. According to the present invention, separation between the alignment layer and the optically anisotropic layer may be improved at the same time, by using a composition containing a radical polymerization initiator, which is capable of generating a halogen radical or a hydrocarbon radical having atoms other than hydrogen atom of the number equal to or smaller than 8, for forming the optically anisotropic layer. According to the embodiment, durability of the optical compensation film as a whole may be improved.

As mentioned above, the optical compensation film of the present invention has not only an advantage achieved by using the cyclic polyolefin polymer film having low moisture permeability, as the support, but also an advantage of being free from failures such as separation at the interface between the support and the alignment layer (and preferably between the alignment layer and the optically anisotropic layer, that is, being excellent in durability.

Paragraphs below will detail materials and methods which can be used in preparing the support, the alignment layer and the optically anisotropic layer.

### (Support)

The optical compensation film of the present invention comprises a cyclic polyolefin polymer film as the support. In the present invention, examples of the cyclic polyolefin polymer include:

addition-(co)polymerization cyclic polyolefins comprising at least one repeating unit represented by formula (I) below,

addition-copolymerization cyclic polyolefins comprising one repeating unit represented by formula (I) and at least one repeating unit represented by formula (II), and

A ring-opening (co)polymerization (co)polymers comprising at least one repeating unit represented by formula (III).

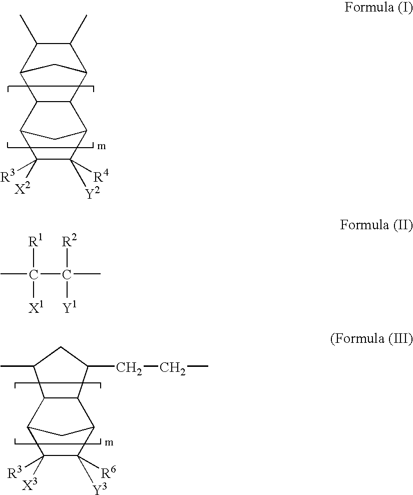

In the formulas, m represents an integer from 0 to 4. R¹ to R⁶ independently represent a hydrogen atom or C₁₋₁₀ hydrocarbon group. X¹ to X³, and Y¹ to Y³ independently represent a hydrogen atom, C₁₋₁₀ hydrocarbon group, halogen atom, C₁₋₁₀ substituted hydrocarbon group of which hydrogen atom(s) is substituted by halogenatom(s), —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙR¹³R¹⁴, —(CH₂)ₙOZ, —(CH₂)ₙW, or (—CO)₂O and (—CO)₂NR¹⁵ configured by X¹ and Y¹, or X² and Y², or X³ and Y³. R¹¹, R¹², R¹³ , R¹⁴ and R¹⁵ independently represent a hydrogen atom, C₁₋₂₀ hydrocarbon group. Z represents a hydrocarbon group or halogen-substituted hydrocarbon group. W represents SiR¹⁶ₚD₃₋ₚ (R¹⁶ represents a C₁₋₁₀ hydrocarbon group, D represents a halogen atom, —OCOR¹⁶ or —OR¹⁶, and p represents an integer from 0 to 3), and n represents an integer from 0 to 10.

In the formula (I), at least two of R³, R⁴, X², and Y² may bind to each other to form a single or polycyclic ring, in which double bond(s) may be embedded. In the formula (III), at least two of R⁵, R⁶, X³, and Y³ may bind to each other to form a single or polycyclic ring, in which double bond(s) may be embedded.

For improving adhesiveness between the support and the alignment layer, it is preferable that X2, X3, Y2 and Y3 independently represent a hydrogen atom or a substituent selected from the group consisting of —(CH₂)ₙCOOR¹¹ and —(CH₂)ₙOCOR¹².

A retardation along thickness direction (Rth) of the film (Rth) may be increased, and a retardation in plane (Re) may be enhanced, by introducing a functional group having large polarizability into substituents on X¹ to X³ and Y¹ to Y³. Films having large Re expressivity may be increased in the Re value, by being stretched in the process of film forming.

Norbornene polymer hydride may be prepared by addition polymerization or methathesis ring-opening polymerization of polycyclic unsaturated compounds, followed by hydrogenation, as described for example in Japanese Laid-Open Patent Publication Nos. H1-240517, H7-196736, S60-26024, S62-19801, Japanese Examined Patent Publication Nos. 2003-1159767 and 2004-309979. In the norbornene polymers used in the present invention, each of R⁵ and R⁶ is preferably a hydrogen atom or CH₃; each of X³ and Y³ are preferably a hydrogen atom, Cl or —COOCH₃; wherein other groups may appropriately be selectable. The norbornene-base resins are commercially available from JSR Corporation under trade names of Arton G and Arton F, and from ZEON Corpoartion under trade names of Zeonor ZF14, ZF16, Zeonex 250 and Zeonex 280, any of these products may be adoptable.

The norbornene-base addition (co)polymerization polymers adoptable herein may be those disclosed in Japanese Laid-Open Patent Publication No. H10-7732, Published Japanese Translations of PCT International Publication No. 2002-504184, US2004229157A1 and Pamphlet of International Patent WO2004/070463A1. Alternatively it may be obtained by addition polymerization of norbornene-base polycyclic unsaturated compounds. Still alternatively, if necessary, norbornene-base polycyclic unsaturated compounds having ester groups may additionally be polymerized with unsaturated olefins such as ethylene, propylene, butene, butadiene and isoprene; or with unsaturated compounds such as acrylonitrile, acrylic acid, methacrylic acid, maleic anhydride, acrylate ester, methacrylate ester, maleimide, vinyl acetate and vinyl chloride. These norbornene-base addition (co)polymerization polymers may also commercially be available. More specifically, they may be available from Mitsui Chemicals, Inc. under the trade name of APEL, graded as APL8008T (Tg=70° C.), APL6013T (Tg=125° C.), APL6015T (Tg=145° C.) and so forth, differed in glass transition point. Pellets called TOPAS8007, ditto 6013, ditto 6015 are available from Polyplastics Co., Ltd. Still alternatively, Appear 3000 is available from Ferrania S.p.A.

Examples, which can be used in the invention, of the cyclic polyolefin polymer obtained by ring-opening polymerization followed by hydrogenation include both of polymers having side chains containing hetero atom(s) and polymers having no side chains containing any hetero atom. As well as that, examples, which can be used in the invention, of the cyclic polyolefin polymers obtained by addition polymerization include both of polymers having side chains containing hetero atom(s) and polymers having no side chains containing any hetero atom. The inventors of the invention found that those having no hetero atoms in the side chains thereof, that is, cyclic polyolefin-base polymers (for example, Zeonor, APEL and TOPAS) composed of hydrocarbons, may be improved in adhesiveness with the alignment layer to a relatively large extent after they are subjected to discharge treatment described later, may keep excellent adhesiveness in a more stable manner, and may preferably be used in terms of improving the adhesiveness. On the other hand, the cyclic polyolefin-base polymers (for example, Arton and Appear 3000) containing hetero atoms in the side chains thereof are relatively poorer in the effect of improving adhesiveness. In some embodiments, the polymers having hetero atoms may be preferable in terms of optical characteristics or the like. According to such the embodiments, the film composed of the polymer having hetero atom(s) may be improved to a practically sufficient level in terms of adhesiveness, and thereby may be used without problems.

The cyclic polyolefin polymer film may be produced according to any method such as solution casting method and melt film-forming method. According to the solution casting method, the polymer is dissolved in a solvent capable of dissolving the polymer, and cast on a surface; and, according to the melt film-forming method, the polymer is melted by heating without solvent, and cast on a surface. The melt film-forming method may be advantageous in that an obtained film may have small optical anisotropy, initial investment may be suppressed because the producing line may be on a relatively small scale, and causative of only a small impact on environment because the process may have no step of vaporizing off the solvent, whereas the method may be disadvantageous in that the rate of film forming is smaller than that in the solution casting method, and thereby the cost may increase, so that the method should appropriately be selected depending on purposes. According to the melt film-forming method, an isotropic film showing no optical anisotropy in the longitudinal direction nor in the thickness-direction in its unstretched state is obtainable; whereas, according to the solution casting method, a film showing optical anisotropy in the thickness-direction is obtainable, because surface alignment can be achieved even in the unstretched state. Either cyclic polyolefin polymer film produced according to either method may preferably be subjected to treatment by stretching, relaxation, or stretching-and-relaxation, after the film forming so as to allow the film to express desired optical characteristics. For example, ZEONOR film, which is produced according to the melt film-forming method, may biaxially be stretched to thereby impart biaxiality characterized by an NZ factor of 1 to 2 or around. Such a film may be used as a support of an optical compensation film for a TN mode LCD. Appear 3000 film, which is produced according to the solution casting method with a solution prepared by dissolving material (s) in methylene chloride, may be stretched using a tenter to thereby impart biaxiality characterized by an NZ factor of 4 to 7 or around. Such a film may be used as a support of an optical compensation film for an OCB mode LCD.

Thickness of the cyclic polyolefin polymer film used as the support is preferably 30 to 200 μm, and more preferably 40 to 120 μm, in terms of ensuring both of thinning and a sufficient level of supporting performance at the same time, although not specifically limited.

In the present invention, the surface of the cyclic polyolefin polymer film is subjected to corona discharge treatment or atmospheric pressure plasma treatment. Although corona discharge treatment is included in a category of atmospheric pressure plasma treatment in a broad sense, it is to be defined herein that treatment by directly exposing a sample film to be treated to a plasma region raised by corona discharge will be referred to as “corona discharge treatment”, and that treatment by placing a surface of a sample film to be treated away from the plasma region will be referred to as “atmospheric pressure plasma treatment”. The corona treatment has extensively been practiced in industrial field and is advantageous in terms of cost, but is disadvantageous in that the surface of a sample film to be treated may physically be damaged to a large extent. On the other hand, the atmospheric pressure plasma treatment has relatively less been practiced, and costs high as compared with the corona treatment, but is advantageous in that the surface of a sample film to be treated may be damaged only to a less degree, and in that intensity of treatment may be adjustable to a relatively high level. Accordingly, either preferable one of the both is selectable, in consideration of tradeoff between damage of the sample film to be used, and a level of improvement in adhesiveness after the treatment.

The surface of the polymer film subjected to the treatment is improved in terms of hydrophilicity. Contact angle of water on the treated surface may be adoptable as an index of improvement in adhesiveness with the alignment layer. More specifically, the contact angle of water on the treated surface is preferably 55° or smaller, and more preferably 50° or smaller. The treated surface having a contact angle of water falling within the above described range may improve adhesiveness with the alignment layer, and may make failures such as separation less likely to occur. The lower limit value is not specifically limited, and is preferably set so as not to break the polymer film. The contact angle may be measured conforming to JIS R3257 (1999). In the corona discharge treatment and the atmospheric pressure plasma treatment, conditions for treatment may be determined so as to make the contact angle fall in the above-described range. Variable conditions for treatment may include applied voltage, frequency, species of atmospheric gas, treatment time and so forth, for either method of treatment.

Details of these treatments are described respectively in “Kobunshi Hyomen Kaisitsu (Polymer Surface Modification)”, published by Kindai Henshu Sha, p. 88-, “Kobunshi Hyomen no Kiso to Oyo (Basics and applications of Polymer Surface)”, Vol. 2, published by Kagakudojin, p. 31-, “Taiki-Atsu Purazuma no Gennri, Tokucho to Kobunshi Firumu·Garasu Kiban no Hyomen Kaishitsu Gijutsu (Principle and Features of Atmospheric Pressure Plasma, and Surface Modification Technology of Polymer Film and Glass Substrate)”, published by (Technical Information Institute Co., Ltd.), the contents of which are referable.

The alignment layer is preferably formed, after removing dust from the surface of the cyclic polyolefin polymer film already subjected to the corona discharge treatment or the atmospheric pressure plasma treatment (occasionally referred to as “treated surface”, hereinafter). Method of removing dust is not specifically limited. Ultrasonic dust removal making use of ultrasonic wave may be preferable. The ultrasonic dust removal is detailed in Japanese Laid-Open Patent Publication No. H7-333613, contents of which are referable.

### (Alignment Layer)

In the optical compensation film of the present invention, the alignment layer is disposed in contact with the treated surface of the cyclic polyolefin polymer film subjected to the corona discharge treatment or the atmospheric pressure plasma treatment (occasionally these may generally be referred to as “discharge treatment”, hereinafter). In terms of further improving adhesiveness between the cyclic polyolefin polymer film and the alignment layer, the alignment layer is preferably formed as follows. A curable composition is applied to the treated surface, and subsequently cured. In particular in an embodiment using a cyclic polyolefin polymer film treated by the corona discharge treatment as the support, the alignment layer may sometimes need further improvement in adhesiveness in terms of materials of the alignment layer. In such an embodiment, the above-described process, or the process of forming the alignment layer by using the curable composition, is particularly effective. Of course, adoption of the above-described method of forming the alignment layer may further improve adhesiveness, also in an embodiment using the cyclic polyolefin polymer film subjected to the atmospheric pressure plasma treatment as the support.

Examples of the alignment layer formed of a curable composition will be described in detail.

The curable composition, which can be used for preparing the alignment layer in the invention, is preferably selected from any compositions capable of curing with irradiation of heat and/or light. Examples of such a curable composition include compositions containing, at least, a polyvinyl alcohol-base polymer and a bifunctional aldehyde. When the composition is applied to the treated surface of the cyclic polyolefin polymer film and then heated, the polyvinyl alcohol-base polymer is crossliked by the bifunctional aldehyde, to thereby give a cured film. Since the crosslinking reaction is accelerated under the presence of acid, an acid may preferably added to the curable composition. The polyvinyl alcohol-base polymers may be any one of unmodified polyvinyl alcohol; modified polyvinyl alcohol having modified OH group; and polyvinyl alcohol derivative having repeating units derived from polyvinyl alcohol and other repeating unit. Among them, those having unsaturated groups such as (meth) acryloyl group in the side chains, as exemplified by polymers No. 1 to No. 24 described in JPA No. H10-218938, are more preferable, because they may further form the crosslinked structure, and may further be improved in the adhesiveness, if they are cured by heating, as being combined with irradiation of ionized radiation, such as ultraviolet ray. In particular, polymers No. 1 to No. 5 described in JPA No. H10-218938 may preferably be used. Examples of the bifunctional aldehyde adoptable herein include glutaraldehyde, glyoxal, malonaldehyde, and succinaldehyde, among which glutaraldehyde is particularly preferable. Examples of the acid adoptable herein include chloric acid, sulfuric acid, nitric acid, phosphoric acid, oxalic acid, salicylic acid, citric acid, and citric acid half ester, among which citric acid half ester is particularly preferable.

Preferable examples of these compounds and preferable ratios of content in the curable composition are described in JPA No. H10-218938, contents of which may be referable.

Examples of the method of coating the curable composition onto the treated surface of the cyclic polyolefin polymer film include spin coating, dip coating, curtain coating, extrusion coating, bar coating and die coating. Liquid for coating may be prepared using a solvent, wherein the solvent is preferably water, or mixed solvent of water and lower alcohol (methanol, ethanol, etc.). The coating may preferably be dried by heating before being cured, or may be allowed to dry and cure at the same time. The curing is preferably proceeded under heating or irradiation of ionized radiation (preferably UV light), and more preferably proceeded under both of heating and irradiation of ionized radiation, which is more specifically irradiation of ionized radiation under heating. Temperature of the curing reaction is preferably room temperature or higher. More specifically, 60 to 180° C. or around is preferable, and 100 to 140° C. or around is more preferable. Irradiation energy per unit area of the ionized radiation (preferably UV light) irradiated for the curing reaction is preferably 20 to 5000 mJ/cm², and more preferably 100 to 800 mJ/cm².

The alignment layer is made from a coating liquid prepared by dissolving the, un-crosslinked, curable composition in a single type of solvent or a mixture of plural types of solvents. The alignment layer having the crosslinked structure therein may show a lowered swellability in a solvent, which is contained as a major solvent in a coating liquid used for preparing the alignment layer. When a mixture of plural types of solvents is used for preparing the coating liquid, “a major solvent” means a solvent having a largest ratio of content in the mixture; and when a single type of solvent is used for preparing the coating liquid, “a major solvent” means the solvent. Lowering in swellability of the alignment layer with respect to the major solvent may be used as an index for degree of proceeding of the crosslinking reaction of the alignment layer. By virtue of the present invention, the adhesiveness between the alignment layer and the cyclic polyolefin polymer film was found to improve as the crosslinking reaction of the alignment layer proceeds. This is presumably due to strengthening the portion, where stress at around the interface with the polymer film may concentrate, that is WBL (weak boundary layer), although the detail remains unknown. The swellability of the alignment layer in the major solvent is preferably 1.0 to 2.0, and more preferably 1.0 to 1.5. If the swellability of the alignment layer in the major solvent is adjusted to fall in the above-described ranges, the adhesiveness between the alignment layer and the cyclic polyolefin polymer film may desirably be improved to a target level.

The swellability of the alignment layer herein is measurable by a method described later in Examples.

The alignment layer is preferably rubbed on the surface thereof. Rubbing may be proceeded according to general procedures. Because dust ascribable to the rubbing may remain on the rubbed surface, the rubbed surface may preferably he subjected to dust removal process before the optically anisotropic layer is formed thereon. Dust removal with ultrasonic may be preferable as a method of dust removal, similarly to as described in the above, although not specifically limited.

Thickness of the alignment layer is preferably 0.01 to 5 μm in general, and more preferably 0.05 to 2 μm, in view of thinning and expression of a sufficient level alignment performance, although not specifically limited.

### (Optically Anisotropic Layer)

The optical compensation film of the present invention comprises the optically anisotropic layer composed of a liquid crystal composition disposed on the alignment layer. The optically anisotropic layer is prepared as follows. A liquid crystal composition is disposed on the alignment layer, aligned in the predetermined alignment state, and then fixed the alignment state. In order to prepare the optically alignment layer according to the above mentioned method, the liquid crystal composition is preferably polymerizable. Enhancement in the adhesiveness between the alignment layer and the optically anisotropic layer may further improve the durability of the entire film. For the purpose of improving the adhesiveness between the alignment layer and the optically anisotropic layer, the optically anisotropic layer is preferably formed using a polymerizable liquid crystal composition containing at least one radical polymerization initiator capable of generating a halogen radical or a hydrocarbon radical having atoms other than hydrogen atom of the number equal to or smaller than 8. More specifically, the layer may preferably be prepared as follows. The polymerizable liquid crystal composition containing the above described radical polymerization initiator is applied to the surface of the alignment layer, and cured via polymerization on the surface of the alignment layer. Use of the polymerization initiator improves the adhesiveness between the alignment layer and the optically anisotropic layer. This presumably results from the fact that less bulky radical may readily diffuse towards the interface with the alignment layer, so that chemical bonds may form also at the interface between the alignment layer and the optically anisotropic layer during the curing process. Therefore, the adhesiveness may be improved. Examples of the halogen radical generated from the radical polymerization initiator include radicals of fluorine, chlorine, bromine and iodine. Chlorine radical is preferable. The hydrocarbon radical, having atoms other than hydrogen atoms of the number equal to or smaller than 8, may be substituted hydrocarbon radical such as halogenated hydrocarbon radical; and examples of the hydrocarbon radical include methyl radical, ethyl radical, propyl radical, butyl radical, phenyl radical, tolyl radical, chlorophenyl radical, bromophenyl radical, and benzoyl radical.

The radical polymerization initiator is preferably such as decomposing to as much as 30% or more at an energy of 100 mJ/cm². Examples of the radical polymerization initiator are shown below, without limiting the present invention.

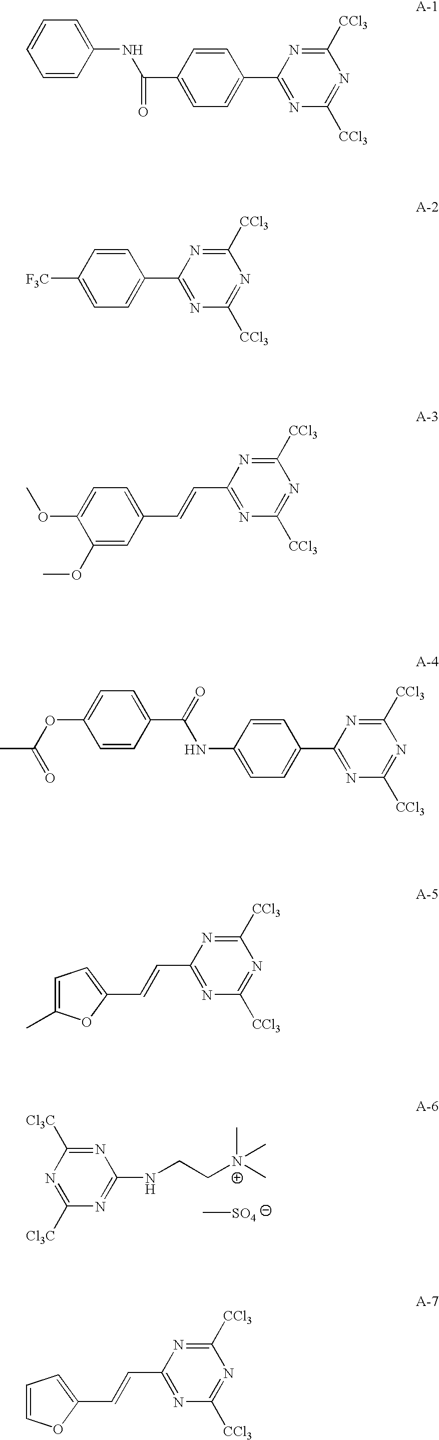

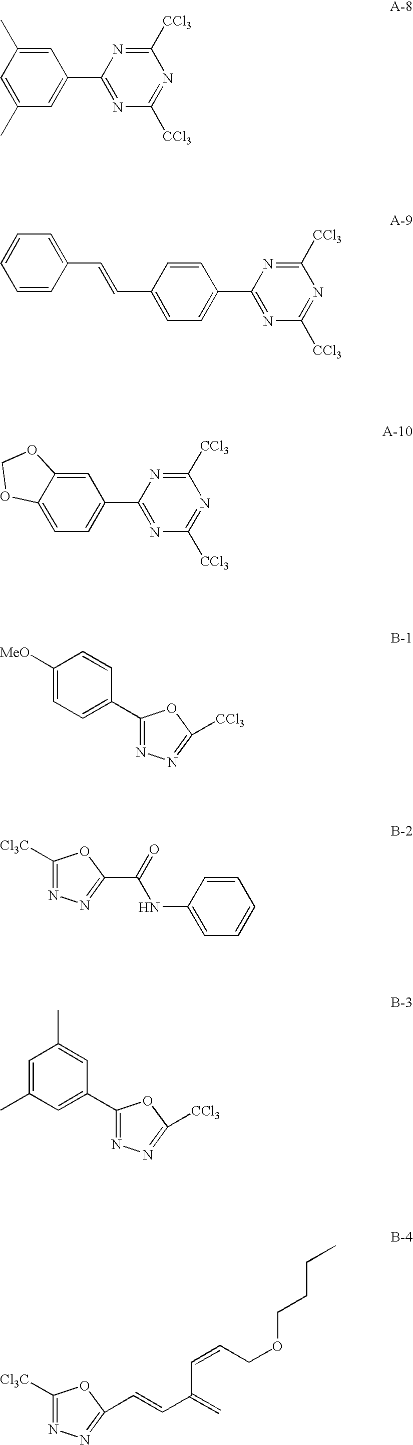

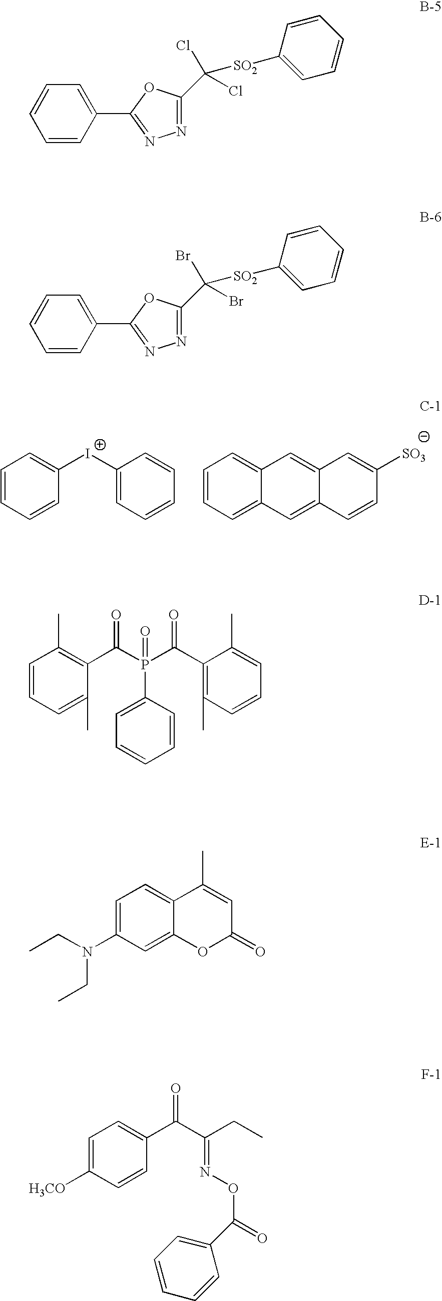

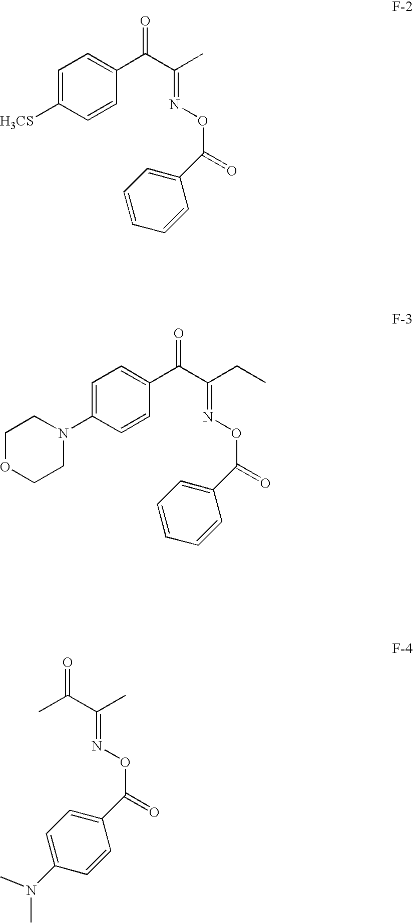

Also the compound expressed by the formula (1) below may preferably be used as the polymerization initiator, since it can produce less bulky radical satisfying the above-described conditions:

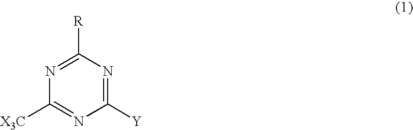

where, X represents a halogen atom; Y represents —CX₃, —NH₂, —NHR′, —NR′₂ or OR′; R′ represents an alkyl group or aryl group; and R represents —CX₃, alkyl group, substituted alkyl group, aryl group, substituted aryl group, or substituted alkenyl group. In terms of producing less bulky radicals and long-term stability in the dissolved state, it is preferable that Y is —CX₃ and R is an aryl group or a substituted aryl group. It is also preferable that R is a group having at least one double bond therein.

Examples of compounds represented by formula (1) employable as the radical polymerization initiator include compounds Nos. 22 to 44 disclosed in paragraphs [0082] to [0084] of JPA No. 2006-251374. In particular, an exemplary compound No. 41 of JPA

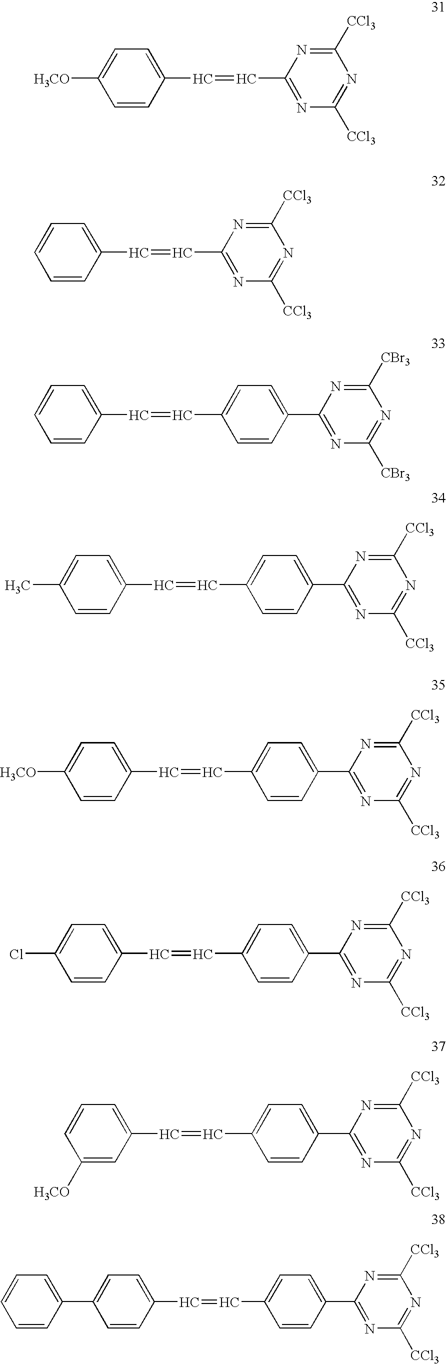

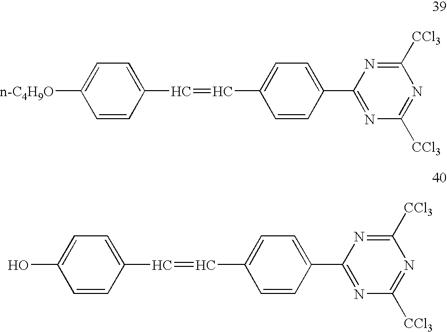

No. 2006-251374 may particularly preferably be used, because it shows large diffusability into the polyvinyl alcohol-base polymer preferably used as the alignment layer of the present invention, and is supposed to show also an effect of promoting the crosslinking reaction of unsaturated groups not only in the optically anisotropic layer, but also inside the alignment layer.

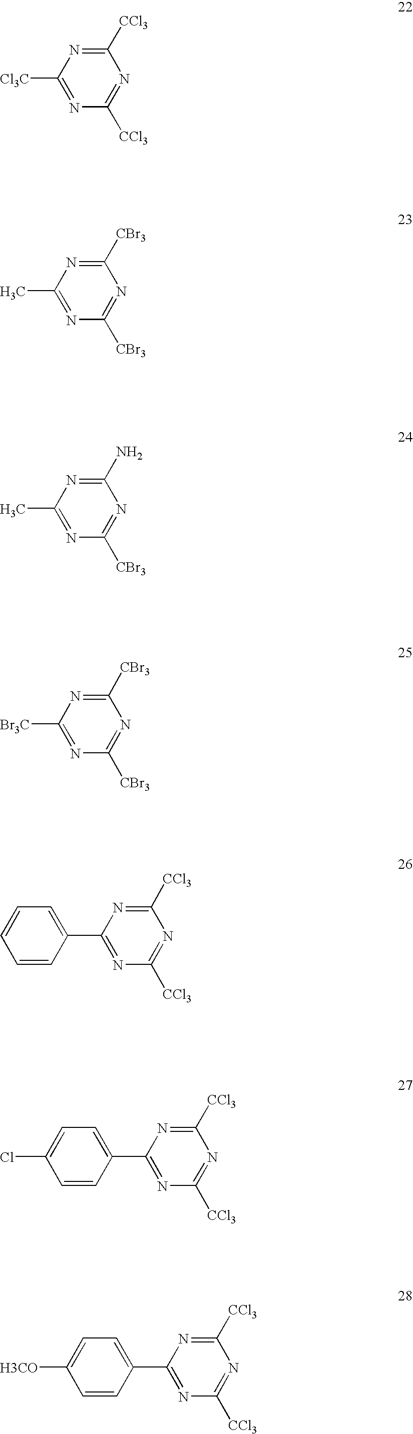

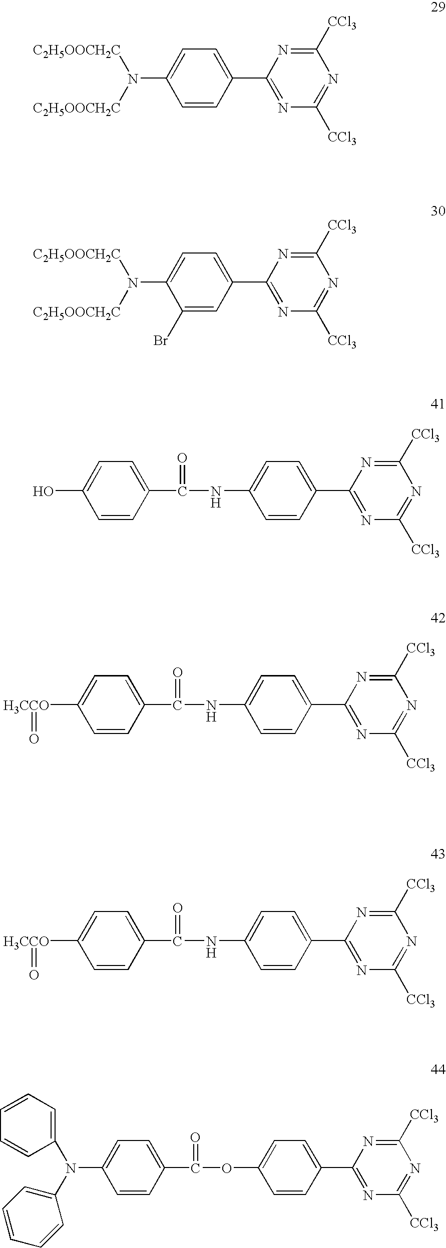

The curable liquid crystal composition contains at least one species of liquid crystalline compound. The liquid crystalline compound may preferably be rod-like liquid crystalline compound or discotic liquid crystalline compound.

Preferable examples of the rod-like liquid crystal compound include azomethines, azoxys, cyanobiphenyls, cyanophenyl esters, benzoate esters, cyclohexane carboxylic acid phenyl esters, cyanophenyl cyclohexanes, cyano-substituted phenyl pyrimidines, alkoxy-substituted phenyl pyrimidines, phenyl dioxanes, tolans and alkenyl cyclohexyl benzonitriles.

Fixing molecules of the rod-like liquid crystal compound in an alignment state may be proceeded according to polymerization or curing-reaction of polymerizable groups which are introduced into the terminal portions of molecules, as well as molecules of a discotic liquid-crystal described hereinafter. An example of fixing molecules of a polymerizable rod-like nematic liquid crystal in an alignment state according to polymerization with UV light is described in JPA No. 2006-209073.

The liquid crystal compound may be selected from not only low-molecular weight liquid crystal compounds, described above, but also high-molecular weight liquid crystal compounds. A high-molecular weight compound is a polymer having side chains corresponding to a residue of low-molecular weight liquid crystal compound. An example of the optical compensation sheet employing a high-molecular weight compound is described in JPA No. hei 5-53016.

Examples of the discotic liquid-crystal compound include benzene derivatives described in “Mol. Cryst.”, vol. 71, page 111 (1981), C. Destrade et al; truxane derivatives described in “Mol. Cryst.”, vol. 122, page 141 (1985), C. Destrade et al. and “Physics lett. A”, vol. 78, page 82 (1990); cyclohexane derivatives described in “Angew. Chem.”, vol. 96, page 70 (1984), B. Kohne et al.; and macrocycles based aza-crowns or phenyl acetylenes described in “J. Chem. Commun.”, page 1794 (1985), M. Lehn et al. and “J. Am. Chem. Soc.”, vol. 116, page 2,655 (1994), J. Zhang et al. The polymerization of discotic liquid-crystal compounds is described, for example, in JPA No. Hei 8-27284 (1996-27284).

An example of polymerization of a discotic liquid crystal compound is described in JPA No. hei 8-27284.

In order to immobilize discotic liquid crystalline molecules by a polymerization, the discotic liquid crystal compounds having at least one polymerizable group(s) are preferable. For example, a polymerizable group may be bonded as a substituent group to a disk-shaped core of the discotic liquid crystalline molecule. In a preferred compound, the disk-shaped core and the polymerizable group are preferably bonded through a linking group, whereby the aligned state can be maintained in the polymerization reaction. Examples of the discotic liquid crystal compound having at least one polymerizable group include the compounds represented by formula (A) below.

D(-L-P)ₙ (A)

In the formula, D is a disk-shaped core, L is a divalent liking group, P is a polymerizable group and n is an integer from 4 to 12.

Examples of the disk-shaped core, D, are shown below. Regarding the examples, LP (or PL) represents a combination of a divalent linking group, L, and a polymerizable group, P.

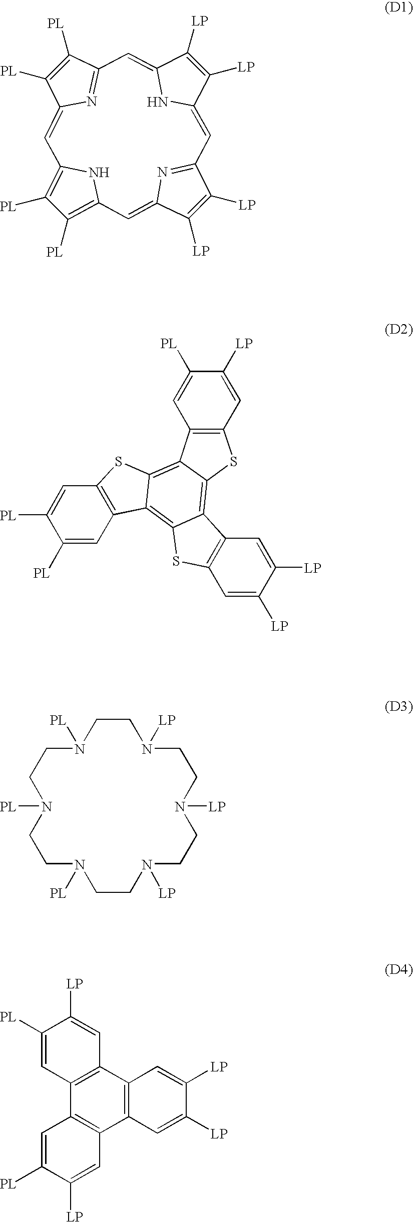

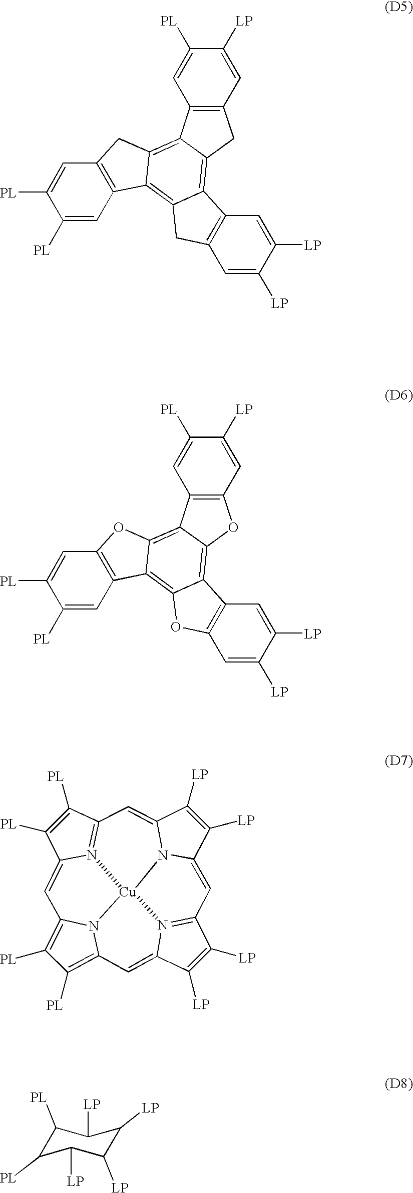

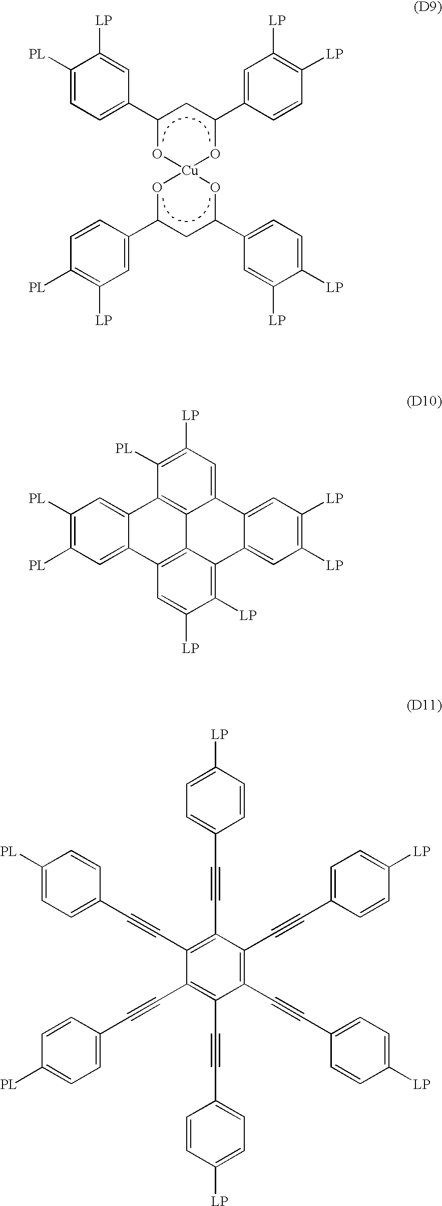

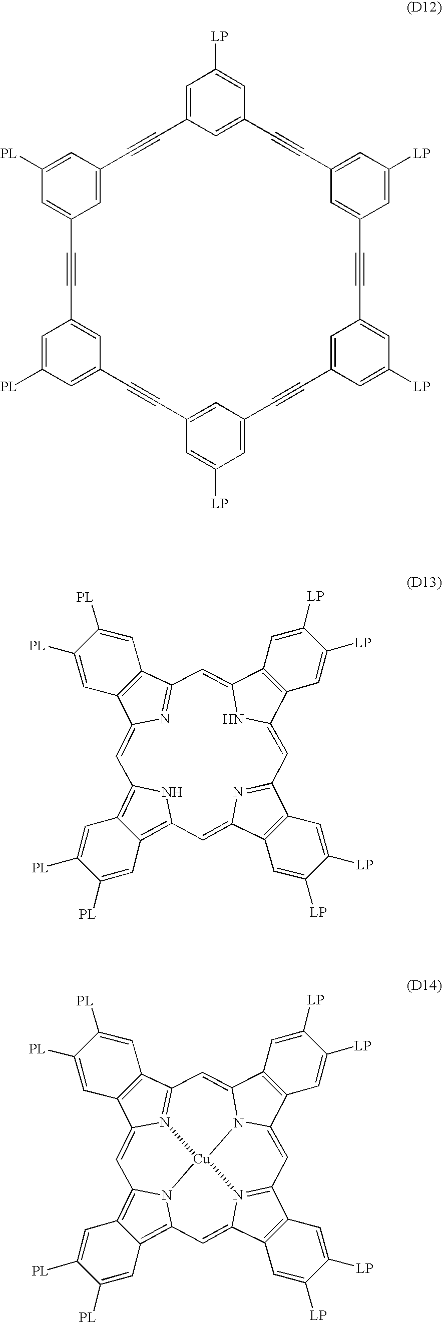

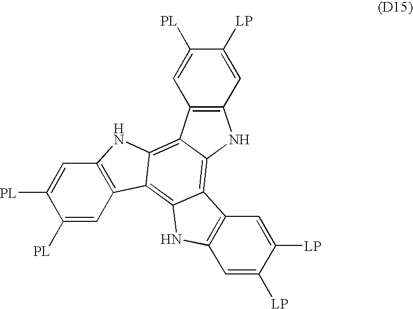

Preferable examples of the discotic liquid crystal compound, which can be used for preparing the optically anisotropic layer, include those described in JPA No. 2006-76992, [0052]; and those described in JPA No. 2007-2220, [0040] to [0063]. For example, the compound represented by formula (D16) is preferable. These discotic liquid crystal compounds show high birefringence and are preferable. Among the compounds represented by formula (D16), compounds having a discotic nematic phase are especially preferable.

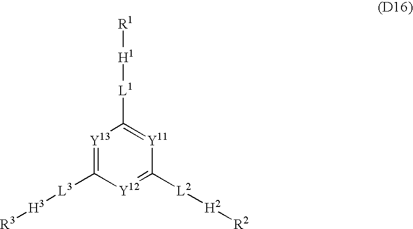

Preferable examples of the discotic liquid crystal compound include those described in JPA No. 2005-301206.

The liquid crystal compounds described in JPA No. 2007-102205 may show birefringence nearer to that of a liquid crystal compound to be used in a liquid crystal cell and are preferable. A preferable example of the core is shown below.

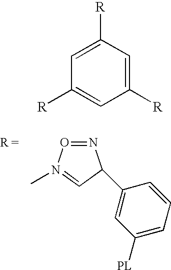

In formula (A), the divalent linking group, L, is preferably selected from the group consisting of alkylenes, alkenylenes, alkenylenes, arylenes, —CO—, —NH—, —O—, —S— and any combinations thereof. The divalent linking group, L, is more preferably any divalent linking group of the combination of at least two selected from the group consisting of alkylenes, arylenes, —CO—, —NH—, —O— and —S—. The divalent linking group, L, is even more preferably any divalent linking group of the combination of at least two selected from the group consisting of alkylenes, arylenes, —CO— and —O—. The number of carbon atoms in the alkylene is preferably from 1 to 12. The number of carbon atoms in the alkenylene is preferably from 2 to 12. The number of carbon atoms in the arylene is preferably from 6 to 10.

Examples of the divalent linking group, L, are shown below. The left side is linked to the disk-shaped core, D; and the right side is linked to the polymerizable group, P. It is to be noted that the alkylene, alkenylene and arylene may have one or more substitutions such as alkyls.

L1: -AL-CO—O-AL-

L2: -AL-CO—O-AL-O—

L3: -AL-CO—O-AL-O-AL-

L4: -AL-CO—O-AL-O—CO—

L5: —CO-AR—O-AL-

L6: —CO-AR—O-AL-O—

L7: —CO-AR—O-AL-O—CO—

L8: —CO—NH-AL-

L9: —NH-AL-O—

L10: —NH-AL-O—CO—

L11: —O-AL-

L12: —O-AL-O—

L13: —O-AL-O—CO—

L14: —O-AL-O—CO—NH-AL-

L15: —O-AL-S-AL-

L16: —O—CO-AR—O-AL-CO—

L17: —O—CO-AR—O-AL-O—CO—

L18: —O—CO-AR—O-AL-O-AL-O—CO—

L19: —O—CO-AR—O-AL-O-AL-O-AL-O—CO—

L20: —S-AL-

L21: —S-AL-O—

L22: —S-AL-O—CO—

L23: —S-AL-S-AL-

L24: —S-AR-AL-

The polymerizable group, P, in the formula may be decided depending on the type of polymerization. Examples of the polymerizable group, P, include those shown below.

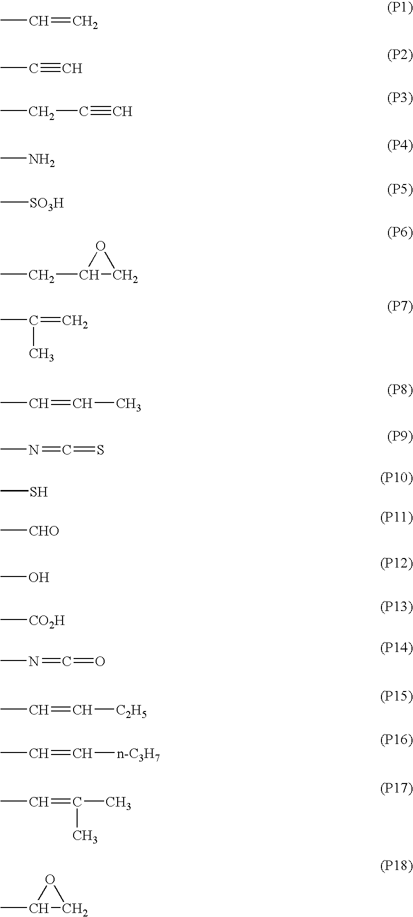

The polymerizable group, P, in formula (A) is preferably selected from unsaturated polymerizable groups such as P1, P2, P3, P7, P8, P15, P16 and P17 or form epoxy groups such as P6 and P18; more preferably from unsaturated polymerizable groups; and even more preferably from ethylene-system unsaturated polymerizable groups such as P1, P7, P8, P15, P16 and P17.

In formula (A), n represents an integer from 4 to 12, and may be decided depending on the type of the disk-shaped core, D. In formula (A), plural combinations of L and P may be same or different from each other, and, preferably, they are same.

In the liquid crystal composition, the liquid crystalline compound preferably accounts for 50% by mass to 99.9% by mass of the total amount of the composition (or the solid content, for the case where solvent is contained), more preferably 70% by mass to 99.9% by mass, and still more preferably 80% by mass to 99.5% by mass.

### (Other Additives)

The liquid crystal composition may comprise one or more additives together with the liquid crystal compound. Examples of the additive include plasticizers, surfactants and polymerizable monomers. These additives may be used for any purpose such as improvement in uniformity of the coated layer, in strength of the film or in alignment degree of the compound. The additive preferably has a compatibility with the liquid crystalline molecules and has a property of not inhibiting the alignment thereof.

Examples of the polymerizable monomer employable in the invention include compounds capable of radical- or cation-polymerization. Preferred are multifunctional radical-polymerization monomers, and more preferred are multifunctional radical-polymerization monomers capable of co-polymerization with the liquid crystal compound. Examples of the employable monomer include the compounds describe in JPA No. 2002-296423, [0018] to [0020]. The amount of the monomer in the composition is preferably from 1 to 50 mass % around and more preferably from 5 to 30 mass % around with respect to the total mass of the liquid crystal compound.

The polymer additive is preferably selected from the polymers capable of increasing the viscosity of a solution thereof; and examples of such a polymer include cellulose esters. Preferred examples of cellulose ester include those described in JPA No. 2000-155216, [0178]. The amount of the polymer additive in the composition is preferably from 0.1 to 10 mass % around, more preferably from 0.1 to 8 mass % around with respect to the amount of the liquid crystal compound for avoiding the inhibition of the alignment of liquid crystal molecules.

Any surfactant may be employed in the invention, and fluorochemical surfactants are preferred. Examples of the surfactant include the compounds described in JPA No. 2001-330725, [0028] to [0056]; and the compounds described in JPA No. 2005-062673, [0069] to [0126]. Preferable examples of the surfactant include fruoloaliphatic-containing polymers described in JPA 2005-292351, [0054] to [0109].

The optically anisotropic layer may be produced as follows. A liquid crystalline composition containing above mentioned ingredients is applied a surface, preferably rubbed surface, of the alignment layer, and aligned at a temperature equal to or lower than the temperature of transferring between a liquid-crystal phase and a solid phase; and, then, polymerization of the composition is carried out with irradiation of UV light so as to fix the alignment state. The composition may be prepared as a coating liquid; and the coating liquid may be applied according to any of known methods (for example, extrusion coating, direct gravure coating, reverse gravure coating, and die coating).

The temperature of transferring between a liquid-crystal phase and a solid phase is preferably from 70° C. to 300° C. around, and more preferably from 70° C. to 170° C. The polymerization of the liquid crystal composition may be carried out according to photo-polymerization reaction. Irradiation of light for polymerizing the liquid crystalline molecules preferably adopts ultraviolet radiation. Irradiation energy is preferably 20 mJ/cm² to 50 J/cm² around, and more preferably 100 to 800 mJ/cm² around. For the purpose of enhancing the photo-polymerization reaction, light may be irradiated under heating conditions. Although the heating condition may not be limited to any range, the temperature is preferably equal to or less that 120° C. around for preventing the alignment degree of the liquid crystal compound from lowering.

Thickness of the optically anisotropic film is preferably 0.5 to 100 μm around, and more preferably 0.5 to 30 μm around.

### [Method of Producing the Optical Compensation Film]

The present invention relates also to a method of producing an optical compensation film having a support, which is a cyclic polyolefin polymer film, and an alignment layer and an optically anisotropic layer formed of a liquid crystal composition in this order. According to the method of the invention, the liquid crystal composition containing a radical polymerization initiator capable of generating a halogen radical or a hydrocarbon radical having a number equal to or smaller than 8 of atoms other than hydrogen atom.

According to one embodiment of the present invention, there is provided the method of producing an optical compensation film, which includes:

(1) subjecting the surface of a cyclic polyolefin polymer film comprising, as a major ingredient, at least one cyclic polyolefin comprising a repeating unit having a cycloaliphatic ring, to corona discharge treatment or atmospheric pressure plasma treatment;

(2) forming an alignment layer on the treated surface of said cyclic polyolefin polymer film treated by corona discharge treatment or atmospheric pressure plasma treatment; and

(3) forming, on the alignment layer, an optically anisotropic layer formed of a liquid crystal composition, in this order.

In this embodiment, the step (2) is preferably a step of forming an alignment layer, by applying a curable composition to the treated surface of the cyclic polyolefin polymer film subjected to corona discharge treatment or atmospheric pressure plasma treatment, and by irradiating, and thereby curing, the composition. Moreover, the treated surface of the cyclic polyolefin polymer film is preferably subjected to dust removal before step (2), and/or the rubbed surface of the alignment layer is preferably subjected to dust removal. The dust removal may preferably be proceeded using ultrasonic wave.

According to another embodiment of the present invention, there is provided a method of producing an optical compensation film, which includes:

(1) subjecting the surface of a cyclic polyolefin polymer film comprising, as a major ingredient, at least one cyclic polyolefin comprising a repeating unit having a cycloaliphatic ring, to corona discharge treatment or atmospheric pressure plasma treatment;

(2) applying a curable composition to the treated surface of the cyclic polyolefin polymer film;

(3) drying the curable composition;

(4) curing the dried curable composition under provision of heat and/or ionized radiation, to thereby form a cured film;

(5) rubbing the surface of the cured film to thereby form an alignment layer;

(6) removing dust from the rubbed surface of the alignment layer; and

(7) forming an optically anisotropic layer composed of a liquid crystal composition, on the rubbed surface having dust removed therefrom,

in this order.

According to still another embodiment of the present invention, there is provided a method of producing an optical compensation film, which includes:

(1) subjecting the surface of a cyclic polyolefin polymer film comprising, as a major ingredient, at least one cyclic polyolefin comprising a repeating unit having a cycloaliphatic ring, to corona discharge treatment or atmospheric pressure plasma treatment;

(2) removing dust from the treated surface of the cyclic polyolefin polymer film;

(3) forming a polymer layer on the treated surface having dust removed therefrom;

(4) rubbing the surface of the polymer layer to thereby form an alignment layer;

(5) removing dust from the rubbed surface; and

(6) forming an optically anisotropic layer on the rubbed surface having dust removed therefrom,

in this order.

### [Evaluation of Optical Properties of Optical Compensation Film]

In the description, Re(λ) and Rth(λ) each indicate a retardation in plane (unit:nm) and a retardation along thickness direction (unit:nm) at a wavelength λ. Re(λ) is measured by applying a light having a wavelength of λ nm in the normal line direction of a sample such as a film, using KOBRA-21ADH or WR (by Oji Scientific Instruments). Selection of wavelength for measuring may be performed by manual change of a wavelength-selection filter or by programming conversion of measured data.

When the sample to be tested is represented by an uniaxial or biaxial refractive index ellipsoid, then its Rth(λ) is calculated according to the method mentioned below.

With the in-plane slow axis (determined by KOBRA 21ADH or WR) taken as the inclination axis (rotation axis) of the sample (in case where the sample has no slow axis, the rotation axis of the sample may be in any in-plane direction of the sample), Re(λ) of the sample is measured at 6 points in all thereof, up to +50° relative to the normal line direction of the sample at intervals of 10°, by applying a light having a wavelength of λ nm from the inclined direction of the sample.

With the in-plane slow axis from the normal line direction taken as the rotation axis thereof, when the sample has a zero retardation value at a certain inclination angle, then the symbol of the retardation value of the sample at an inclination angle larger than that inclination angle is changed to a negative one, and then applied to KOBRA 21ADH or WR for computation.

With the slow axis taken as the inclination axis (rotation axis) (in case where the sample has no slow axis, the rotation axis of the sample may be in any in-plane direction of the film), the retardation values of the sample are measured in any inclined two directions; and based on the data and the mean refractive index and the inputted thickness of the sample, Rth may be calculated according to the following formulae (10) and (11):

$$\begin{matrix}Re ( θ ) = [ nx - \frac{ny \times nz}{\sqrt{{\{ ny sin ( {sin}^{- 1} ( \frac{sin ( - θ )}{nx} ) ) \}}^{2} + {\{ nz cos ( {sin}^{- 1} ( \frac{sin ( - θ )}{nx} ) ) \}}^{2}}} ] \times \frac{d}{cos \{ {sin}^{- 1} ( \frac{sin ( - θ )}{nx} ) \}} & ( 10 ) \\ Rth = \{ ( nx + ny ) / 2 - nz \} \times d & ( 11 )\end{matrix}$$

wherein Re(θ) means the retardation value of the sample in the direction inclined by an angle θ from the normal line direction; nx means the in-plane refractive index of the sample in the slow axis direction; ny means the in-plane refractive index of the sample in the direction vertical to nx; nz means the refractive index of the sample vertical to nx and ny; and d is a thickness of the sample.

When the sample to be tested can not be represented by a monoaxial or biaxial index ellipsoid, or that is, when the sample does not have an optical axis, then its Rth(λ) may be calculated according to the method mentioned below.

With the in-plane slow axis (determined by KOBRA 21ADH or WR) taken as the inclination axis (rotation axis) of the sample, Re(λ) of the sample is measured at 11 points in all thereof, from −50° to +50° relative to the normal line direction of the sample at intervals of 10°, by applying a light having a wavelength of λ nm from the inclined direction of the sample. Based on the thus-determined retardation data of Re(λ), the mean refractive index and the inputted thickness of the sample, Rth(λ) of the sample is calculated with KOBRA 21ADH or WR.

The mean refractive index may be used values described in catalogs for various types of optical films. When the mean refractive index has not known, it may be measured with Abbe refractometer. The mean refractive index for major optical film is described below: cellulose acetate (1.48), cycloolefin polymer (1.52), polycarbonate (1.59), polymethylmethacrylate (1.49), polystyrene (1.59).

The mean refractive index and the film thickness are inputted in KOBRA 21ADH or WR, nx, ny and nz are calculated therewith. From the thus-calculated data of nx, ny and nz, Nz=(nx−nz)/(nx−ny) is further calculated.

In the description, when there is no notation regarding the measurement wavelength, the measurement wavelength for Re or Rth is 550 nm.

### [Polarizing Plate]

The present invention relates also to a polarizing plate having at least a polarizer film and the optical compensation film of the present invention. One embodiment of the polarizing plate of the present invention has the optical compensation film of the present invention as a protective film on one surface of the polarizer film. In such an embodiment, the cyclic polyolefin polymer film as the support may preferably be bonded to the surface of the polarizer film, after treating the back surface thereof (the surface having no alignment layer formed thereon) by hydrophilization similarly to the surface treatment used in the method of the present invention. Because, in this embodiment, the cyclic polyolefin polymer film, causing only small changes in Re and Rth in response to changes in moisture, is bonded between the polarizer film and a liquid crystal cell, changes in display characteristics (hue and viewing angle) induced by environmental moisture may be reduced to a large extent.

Examples of the polarizer film, which can be used herein, include those obtained by stretching a polyvinyl alcohol film dyed with iodine.

The polarizer film preferably has a protective film formed also on the other surface thereof. Cellulose acylate film, cyclic polyolefin polymer film, and so forth may be used as the protective film.

### [Liquid Crystal Display Device]

The optical compensation film and the polarizing plate of the invention may be used in liquid crystal display devices employing any mode such as TN (Twisted Nematic), IPS (In-Plane Switching), FLC (Ferroelectric Liquid Crystal), OCB (Optically Compensatory Bend), STN (Supper Twisted Nematic), VA (Vertically Aligned) and HAN (Hybrid Aligned Nematic).

### EXAMPLES

The invention is described more concretely with reference to the following Examples, in which the material and the reagent used, their amount and the ratio, the details of the treatment and the treatment process may be suitably modified or changed not overstepping the sprit and the scope of the invention. Accordingly, the invention should not be limited by the Examples mentioned below.

### Example 1

### (Preparation of Support 1)

Arton (from JSR Corporation), which is a film of cyclic polyolefin polymer comprising a repeating unit having side chains containing at least one oxygen atom, which is one of hetero atoms, was dissolved into dichloromethane to prepare a solution. A film was prepared by using the solution according to a solution casting method, stretched in the longitudinal direction and relaxed in the transverse direction using a FITZ stretching machine (from the Ichikin, Ltd.), to thereby obtain a biaxial film of 1500 mm wide, 3000 m long, 80 μm thick, having the slow axis in the transverse direction, a retardation in plane, Re, of 80 nm, and a retardation along thickness direction, Rth, of 60 nm. One surface of the film was subjected to corona discharge treatment (electrode: from Vetaphone A/S, Corona-Plus, generator: CPlC, output power: 900 Watt·min/m², film feed speed: 6 m/min). Contact angle of water on the surface after corona discharge treatment, measured conforming to JIS R3257 (1999), was found to be 50°. The cyclic polyolefin polymer film thus treated by the corona discharge treatment was used as Support 1.

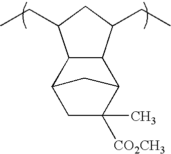

### (Formation of Alignment Layer 1)

Support 1 was subjected to ultrasonic dust removal so as to remove dust from the surface treated by corona discharge. After the dust removal, a curable composition 1 for forming an alignment layer, having the formulation shown below, was applied to the surface treated by corona discharge, using a #24 wire bar to as much as 24 ml/cm² on the wet basis, dried at 100° C. for 2 minutes, then heated at 130° C. for 2.5 minutes, irradiated with UV light at an energy of irradiation of 300 mJ/cm², to thereby form a cured layer 1. Thickness of layer 1 was 1.0 μm.

### Curable Composition 1 for Forming Alignment Layer

Modified polyvinyl alcohol expressed by the formula below

| | |
|---|---|
| | 40 parts by mass |
| Water | 728 parts by mass |
| Methanol | 228 parts by mass |
| Glutaraldehyde | 2 parts by mass |
| Citric acid | 0.08 parts by mass |
| Citric acid monoethyl ester | 0.29 parts by mass |
| Citric acid diethyl ester | 0.27 parts by mass |
| Citric acid triethyl ester | 0.05 parts by mass |

### Modified Polyvinyl Alcohol

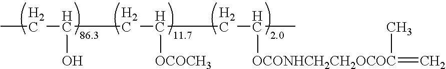

It is to be noted that continuous producing was performed as follows. The corona discharge treatment apparatus was disposed at around the feed-out portion of the preparing line of alignment layers; the ultrasonic dust removal apparatus was disposed just behind the corona discharge treatment apparatus; and a coater unit for coating the curable composition for alignment layer was disposed therebehined. After the film was processed by these apparatuses in this order, subsequently it was fed into a drying zone and a curing zone, and was processed by a UV irradiation apparatus, and finally was taken up by a take-up unit in a roll. Then, the cured layer was formed on a long film (Support 1) in a continuous fashion. The cured layer was used as Alignment layer 1 after being subjected to a rubbing treatment described below.

### (Formation of Optically Anisotropic Layer 1)

The rolled film having the cured layer thereon was set on the feed-out side of the producing line of the optically anisotropic layer, the fed-out film was rubbed using a rubbing apparatus disposed therebehind, by allowing a rubbing roll to rotate in the direction reverse to the direction of feeding, and the rubbed surface was then subjected to ultrasonic dust removal. After the dust removal, a liquid crystal composition 1 for forming the optically anisotropic layer, having the formulation shown below, was coated on the rubbed surface using a #2 wire bar to as much as 3.5 ml/cm² on the wet basis, the coated film was dried at 120° C. for 1.5 minutes so as to proceed alignment, then irradiated with UV light using a 120-W/cm metal halide lamp at an energy or irradiation of 200 mJ/cm² while keeping the film at 80° C., so as to proceed the polymerization reaction and to fix the alignment state, to thereby form optically anisotropic layer 1, and the film was taken up in a take-up unit to produce a roll. Thickness of optically anisotropic layer 1 was 1.4 μm.

Only optically anisotropic layer 1 of the obtained film was transferred onto a glass plate, and optical characteristics were measured using KOBRA 21ADH at 550 nm, to find Re=30 nm and Rth=90 nm.

Liquid Crystal Composition 1 for Forming Optically Anisotropic
Layer

| | |
|---|---|
| Methyl ethyl ketone | 102.00 parts by mass |
| Discotic liquid crystalline compound-1 expressed by the formula | 41.01 parts by mass |
| below | |
| Ethylene oxide-modified trimethylolpropane acrylate (V360, from | 4.06 parts by mass |
| Osaka Organic Chemical Industry, Ltd.) | |
| Cellulose acetate butyrate (CAB531-1, from Eastman Chemical | 0.11 parts by mass |
| Company) | |
| Cellulose acetate butyrate (CAB551-0.2, from Eastman Chemical | 0.34 parts by mass |
| Company) | |
| Polymerization initiator expressed by the formula below | 1.80 parts by mass |
| Fluoroaliphatic group-containing polymer 1 expressed by the | 0.03 parts by mass |
| formula below | |
| Fluoroaliphatic group-containing polymer 2 expressed by the | 0.23 parts by mass |
| formula below | |

Discotic Liquid crystalline Compound-1

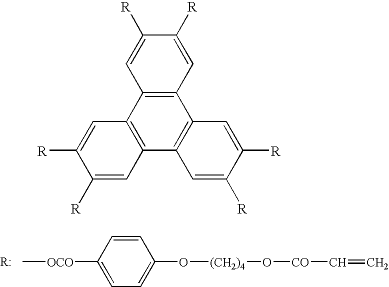

### Polymerization Initiator

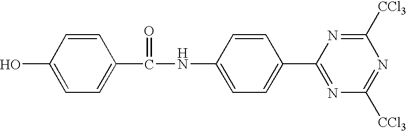

Fluoroaliphatic Group-Containing polymer 1 [a/b=90/10 (Mass % Basis)]

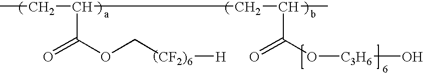

Fluoroaliphatic Group-Containing polymer 2 [a/b=98/2 (Mass % Basis)]

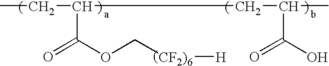

In this way, optical compensation film 1 comprising support 1, alignment layer 1, and optically anisotropic layer 1 was produced.

### (Evaluation of Adhesiveness)

Adhesiveness at the interface between the support and the alignment layer, and the interface between the alignment layer and the optically anisotropic layer were evaluated according to the method below. Results are shown in Table 1.

The adhesiveness was evaluated as follows. Test pieces (samples consisting of the film and the alignment layer thereon, or samples consisting of the film, the alignment layer and the optically anisotropic layer thereon) were prepared according to JIS K 5400, 8.5.2 “Cross-cut adhesion tape test”. In the evaluation, not only a cellophane adhesive tape (tape 1) specified by the JIS standard, but also a polyester adhesive tape NO31RH (tape 2) from Nitto Denko Corporation, and an polyester adhesive tape NO31B (tape 3) from Nitto Denko Corporation, as an adhesive tape with stronger adhesiveness for ensuring a condition of forced peeling, were similarly used, so as to give adhesiveness evaluation (forced).

### Example 2

### (Preparation of Support 2)

Appear 3000 (from Ferrania S.p.A.), which is a cyclic polyolefin polymer comprising a repeating unit shown below, was dissolved into dichloromethane to prepare a solution similarly to as described in Example 1; and a film was prepared by using the solution according to a solution casting method, and stretched in the transverse direction and in the longitudinal direction, to thereby obtain a biaxial film of 1500 mm wide, 3000 m long, 80 μm thick, having the slow axis in the transverse direction, a retardation in plane, Re, of 30 nm, and a retardation along thickness direction, Rth, of 330 nm. One surface of the film was subjected to corona discharge treatment similarly to as described in Example 1. Contact angle of water on the surface treated by corona discharge was found to be 40°. The cyclic polyolefin polymer film thus treated by the corona discharge treatment was used as support 2.

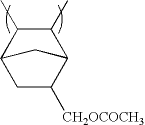

The alignment layer and the optically anisotropic layer were formed similarly to as described in Example 1, except that support 2 was used in place of support 1, and that the direction of rubbing of the alignment layer was set to 45° away from the longitudinal direction of the support, and thereby optical compensation film 2 was produced. Adhesiveness was evaluated similarly to as described in Example 1. Results are shown in Table 1.

### Example 3

### (Preparation of Support 3)

A biaxial film of 1500 mm wide, 3000 m long, 80 μm thick, having the slow axis in the transverse direction, a retardation in plane, Re, of 80 nm, and a retardation along thickness direction, Rth, of 60 nm, was prepared similarly to as described in Example 1, except that the surface treatment was carried out by atmospheric pressure plasma treatment (electrode: from Sekisui Chemical Co., Ltd., conditions: atmospheric oxygen concentration: 3 vol % (97% nitrogen), frequency: 30 Hz, film feed speed: 1 m/min). Contact angle of water on the surface subjected to the plasma treatment, measured similarly to as described in the above, was found to be 35° The cyclic polyolefin polymer film thus treated by the atmospheric pressure plasma treatment was used as support 3.

The alignment layer and the optically anisotropic layer were formed similarly to as described in Example 1, except that support 3 was used in place of support 1, and thereby optical compensation film 3 was produced. Adhesiveness was evaluated similarly to as described in Example 1. Results are shown in Table 1.

### Example 4

Support 4 was prepared similarly to as described in Example 1, except that the film was stretched in the longitudinal direction and in the transverse direction (Re: 0.7 nm, Rth: 41 nm, thickness: 90 μm), and thereafter alignment layer 1 was formed in the same manner as described in the above.

### (Formation of Optically Anisotropic Layer 4)

The rubbed surface of alignment layer 1 was subjected to ultrasonic dust removal. After the dust removal, a liquid crystal composition 4 for forming the optically anisotropic layer, having the formulation shown below, was applied to the rubbed surface using a #4 wire bar, the coated film was dried at 100° C. for 3 minutes so as to proceed alignment, then irradiated by UV light at an energy or irradiation of 100 mJ/cm² so as to proceed the polymerization reaction and to fix the state of alignment, to thereby form optically anisotropic layer 4. Thickness of optically anisotropic layer 4 was 1.2 μm. Only the optically anisotropic layer of the obtained film was transferred onto a glass plate, and optical characteristics were measured using KOBRA 21ADH at 550 nm, to find Re=30 nm and Rth=−80 nm.

Liquid Crystal Composition 4 for Forming Optically Anisotropic
Layer

| | |
|---|---|
| Toluene | 100 parts by mass |
| Polymerizable rod-like liquid crystalline | 20 parts by mass |
| compound-1 having a structure below | |
| Irgacure 907 | 1 part by mass |
| (trade name, from CIBA Specialty Chemicals Inc.) | |

### Polymerizable Rod-Like Liquid Crystalline Compound-1

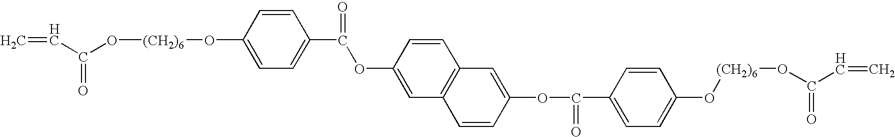

In this way, optical compensation film 4 comprising support 4, alignment layer 1, and optically anisotropic layer 4 was produced. Adhesiveness was evaluated similarly to as described in the Example 1. Results are shown in Table 1.

### Comparative Example 1

### (Preparation of Support C1)

A film was prepared according to a solution casting method in the same manner as support 1, using a solution containing a cyclic polyolefin polymer Arton (from JSR Corporation) as a source material, but was remained untreated thereafter. The un-treated cyclic polyolefin polymer film was used as support C1.

The alignment layer and the optically anisotropic layer were formed similarly to as described in Example 1, except that support C1 was used in place of support 1, and thereby optical compensation film C1 was produced. Adhesiveness was evaluated similarly to as described in Example 1. Results are shown in Table 1.

### Comparative Example 2

### (Preparation of Support C2)

A film was prepared according to a solution casting method similarly to support 2, using a solution containing a cyclic polyolefin polymer Appear 3000 (from Ferrania S.p.A.) as a source material, but was remained untreated thereafter. The untreated cyclic polyolefin polymer film was used as support C2.

The alignment layer and the optically anisotropic layer were formed similarly to as described in Example 1, except that support C2 was used in place of support 1, and thereby optical compensation film C2 was produced. Adhesiveness was evaluated similarly to as described in Example 1. Results are shown in Table 1.

TABLE 1

| | | Example 1 | Example 2 | Example 3 | Example 4 |
|---|---|---|---|---|---|
| Support | | Arton | Appear 3000 | Arton | Arton |
| (Thickness) | | (70 μm) | (80 μm) | (70 μm) | (70 μm) |
| Surface treatment | | Corona | Corona | Plasma | Corona |
| (contact angle | | treatment | treatment | treatment | treatment |
| of water) | | (50°) | (50°) | (35°) | (50°) |
| Alignment layer | | Curable | Curable | Curable | Curable |
| | | composition 1 | composition 1 | composition 1 | composition 1 |
| Optically | | Liquid | Liquid | Liquid | Liquid |
| anisotropic layer | | crystal | crystal | crystal | crystal |
| | | composition 1 | composition 1 | composition 1 | composition 4 |
| Total | | ⊚ | ⊚ | ⊚ | ⊚ |
| Support/ | Tape 2 | A | A | A | A |
| alignment | Tape 3 | A | A | A | A |
| layer | Tape 1 | A | A | A | A |
| interface | | | | | |
| Alignment | Tape 2 | A | A | A | A |
| layer/ | Tape 3 | A | A | A | A |
| optically | Tape 1 | A | A | A | A |
| anisotropic | | | | | |
| layer | | | | | |
| interface | | | | | |

| | | Comparative Example 1 | Comparative Example 2 |
|---|---|---|---|
| Support | | Arton | Appear |
| (Thickness) | | (70 μm) | 3000 |
| | | | (80 μm) |
| Surface treatment | | None (69°) | None (70°) |
| (contact angle of water) | | | |
| Alignment layer | | Curable | Curable |
| | | composition 1 | composition 1 |
| Optically | | Liquid crystal | Liquid crystal |
| anisotropic layer | | composition 1 | composition 1 |
| Total | | x | x |
| Support/ | Tape 2 | E | E |
| alignment | Tape 3 | E | E |
| film interface | Tape 1 | E | E |
| Alignment film/ | Tape 2 | E | E |
| optically anisotropic | Tape 3 | E | E |
| layer interface | Tape 1 | E | E |

Tape 1: cellophane adhesive tape specified by JIS Standard;
Tape 2: polyester adhesive tape NO31RH from Nitto Denko Corporation; and
Tape 3: polyester adhesive tape NO31B (tape 3) from Nitto Denko Corporation.

The evaluation standards in the table are as follows.

### [Evaluation Standards of Adhesiveness]

A: There is no peel-off in any of all grids in the cross-cut area.

B: There is peel-off in an area equal to or less than 10% of all grids in the cross-cut area.

C: There is peel-off in an area falling within from 11 to 25% of all grids in the cross-cut area.

D: There is peel-off in an area falling within from 26 to 50% of all grids in the cross-cut area.

E: There is peel-off in an area equal to or larger than 51% of all grids in the cross-cut area.

### [Summative Evaluation Standards]

⊚: There is no peel-off at both of the interface between the support and the alignment layer and the interface between the alignment layer and the optically anisotropic layer.

∘: There is no peel-off at either the interface between the support and the alignment layer or the interface between the alignment layer and the optically anisotropic layer.

×: There is peel-off at both of the interface between the support and the alignment layer and the interface between the alignment layer and the optically anisotropic layer.

From the results shown in Table 1, it can be understood that the optical compensation films of Examples of the present invention are more excellent in the durability on the total basis, as compared with Comparative Examples using the supports treated neither by corona discharge treatment nor by atmospheric pressure plasma treatment.

### Examples 5 to 7

Optical compensation films 5 to 7 were produced similarly to the preparation of optical compensation film 1, except that, in the process of forming the alignment layer, the film was cured by heating at 130° C. for 2.5 minutes but not irradiated with UV light in Example 5, the film was cured without heating but only irradiated with UV light at an energy of irradiation of 300 mJ/m² in Example 6, and the film was only dried at 100° C. but was not heated nor irradiated with UV light thereafter in Example 7.

Adhesiveness was measured in the same manner as optical compensation film 1. Results are shown in Table 2. Table 2 shows again the results of evaluation of optical compensation film 1 produced in Example 1.

Swellability of each of thus-formed alignment layer was measured according to the method described below. Results are shown in Table 2.

Each of the films subjected to measurement of swellability was sliced using a microtome to thereby prepare a slice of approximately 200 nm thick, and the slice was observed under a TEM at a 10,000× to 30,000× magnification. Another slice of the same film was immersed into pure water at 25° C. for 5 minutes, and the swelled alignment layer was observed under the TEM at the same magnification. These procedures were repeated three times, and ratio of average values of thickness of the alignment layer before and after 30-minute immersion {(average thickness of swelled alignment layer)÷(average thickness of unswelled alignment layer)} was defined as swellability.

TABLE 2

| | | Example 1 | Example 5 | Example 6 | Example 7 |
|---|---|---|---|---|---|
| Curing of | Heating | Yes | Yes | No | No |
| alignment | UV | Yes | No | Yes | No |
| layer | irradiation | | | | |

| Total | | ⊚ | ∘ | ∘ | ∘ |
|---|---|---|---|---|---|
| Support/ | Tape 2 | A | A | B | E |
| alignment layer | Tape 3 | A | C | E | E |
| interface | Tape 1 | A | E | C | E |
| Alignment | Tape 2 | A | A | A | A |
| layer/optically | Tape 3 | A | A | A | A |
| anisotropic | Tape 1 | A | A | A | A |
| layer | | | | | |
| interface | | | | | |

| | | | | |
|---|---|---|---|---|
| Swellability of | 1.1 | 1.3 | 1.5 | 2.4 |
| alignment layer | | | | |

From the results shown in Table 2, it can be understood that the alignment layers formed using the curable composition were further improved in the adhesiveness at the support/alignment layer interface, and those subjected both to heating and UV irradiation in the process of curing were still further improved in the adhesiveness.

Examples 1 and 5 were desirable, and Example 1 was most desirable. The reason that Examples 6 and 7 were inferior as compared with Examples 1 and 5 is as follows. Examples 6 and 7 seemed to show no problem in the adhesiveness in the final product form, but were found to be poor in the adhesiveness at the stage of intermediate product having the alignment layer just formed thereon, raising a risk of degrading yield ratio in the process of producing, because there may be some troubles to be occurred during handling in the next step, or troubles of partial transfer of the alignment layer onto the back surface of the support, when the intermediate product having the alignment layer just formed thereon was stored in a form of web roll.

In those respects, Examples 1 and 5 were desirable, and Example 1 was most desirable.

### Example 8

Zeonor ZF-14 (from ZEON Corporation), which is a cyclic polyolefin polymer film containing no hetero atom in the side chains thereof, was stretched in the transverse direction and relaxed in the longitudinal direction using a FITZ stretching machine (from the Ichikin, Ltd.), to thereby prepare a biaxial film of 95 μm thick, having a retardation in plane, Re, of 80 nm, and a retardation along thickness direction, Rth, of 60 nm. One of the surfaces was subjected to corona discharge treatment similarly to as described in Example 1. Contact angle of water on the surface treated by the corona discharge treatment was found to be 400. The cyclic polyolefin polymer film thus treated by the corona discharge treatment was used as support 9.

The alignment layer and the optically anisotropic layer were prepared similarly to as described in Example 7, except that support 9 was used in place of support 1, and thereby optical compensation film 8 was produced. Adhesiveness was evaluated in same manner as described in Example 1. Results are shown in Table 4.

### Examples 9 to 15

Optical compensation films 9 to 15 were prepared in the same manner as optical compensation film 1, except that liquid crystal compositions 9-15 prepared by using 36.91 parts by mass of discotic liquid crystal compound-2A and 4.10 parts by mass of discotic liquid crystal compound-2B, which are shown in Table 3, were used in place of liquid crystal composition 1 respectively for preparing the optically anisotropic layers 9-15. Each of the optically anisotropic layers 9-15 was 1.1 μm. only optically anisotropic layers 9-15 of the obtained films were transferred onto a glass plate respectively, and optical characteristics were measured using KOBRA 21ADH at 550 nm, to find that all of the films had Re=30 nm and Rth=90 nm.

TABLE 3

| | Discotic Liquid crystal | Discotic Liquid crystal |
|---|---|---|
| No. | Compound-2A | Compound-2B |
| Example 9 | D-112 described in JPA No. 2006-76992 | |
| Example | D-112 described in | Discotic Liquid crystal |
| 10 | JPA No. 2006-76992 | Compound-1 |
| | | used in Example 1 |
| Example | D-304 described in | Discotic Liquid crystal |
| 11 | JPA No. 2006-76992 | Compound-1 |
| | | used in Example 1 |
| Example | D-224 described in | Discotic Liquid crystal |
| 12 | JPA No. 2007-2220 | Compound-1 |
| | | used in Example 1 |
| Example | D-227 described in | Discotic Liquid crystal |
| 13 | JPA No. 2007-2220 | Compound-1 |
| | | used in Example 1 |
| Example | D-10 described in | Discotic Liquid crystal |
| 14 | JPA No. 2007-2220 | Compound-1 |
| | | used in Example 1 |
| Example | D-286 described in | Discotic Liquid crystal |
| 15 | JPA No. 2007-2220 | Compound-1 |
| | | used in Example 1 |

Regarding optical compensation films 9-15 prepared in Examples 9-15, adhesiveness was evaluated in same manner as described in Example 1. Results are shown in Table 4. It is to be noted that, in Table 4, only the results of Examples 8 and 9 (optical compensation films 8 and 9) are shown. The results of Examples 10-15 (optical compensation films 10-15) were nearly equal to those of Example 9.

TABLE 4

| | | Example 8 | Example 9 |
|---|---|---|---|
| Support/ | Tape 2 | A | A |
| alignment layer | Tape 3 | A | A |
| interface | Tape 1 | A | A |
| Alignment | Tape 2 | A | A |
| layer/optically | Tape 3 | A | A |
| anisotropic layer | Tape 1 | A | A |
| interface | | | |

It can be understood that optical compensation films 8-15 were better in terms of adhesiveness of the interface between the support and the alignment layer, compared with Example 7.

We obtained surface analysis data suggesting that hydrophilic groups were introduced into ZEONOR, containing no hetero atom, by a corona discharge treatment in a high degree. And from the data, although the detail remains unknown, the fact that Example 8 was better than Example 7 is presumably due to improvement in adhesiveness of the film to the high-hydrophilic alignment layer.

It can be summarized as follows. From the results shown in tables 2 and 4, it can be understood that, by using a polymer film of cyclic polyolefin polymer having no hetero atom in the side chains, adhesiveness of the film to an alignment layer can be improved according to the simple process.

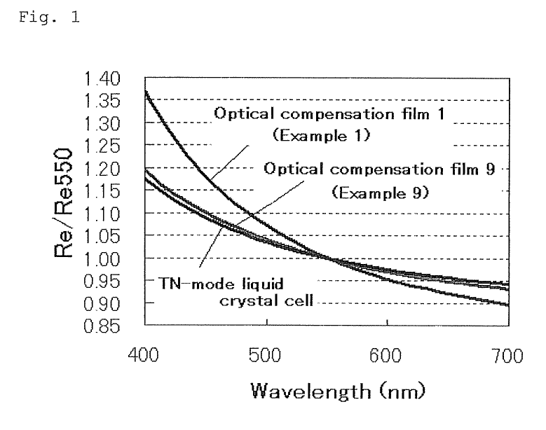

Furthermore, regarding optical compensation films 1 and 9-15 prepared in Examples 1 and 9-15 respectively, Re was measured at each wavelength ranging from 400 nm to 700 nm by 10 nm, and the data of Re(λ)/Re(550), which were obtained by dividing Re at a wavelength λ, Re(λ), by Re at 550 nm, Re(550), were plotted along the longitudinal axis against the horizontal axis of the measuring wavelength λ to make a graph. The graph is shown in FIG. 1.

In FIG. 1, only the data of Examples 1 and 9 were plotted. The data of Examples 10-15 were similar to those of Example 9. For reference, in FIG. 1, as well as the data of Re(λ)/Re(550),the data of Δn·d(λ)/Δn·d(550), which were obtained by dividing Δn·d at a wavelength λ, Δn·d (λ), by Δn·d at 550 nm, Δn·d (550), of a general TN-mode liquid crystal cell were plotted as referential data.

From the results shown in FIG. 1, it can be understood that optical compensation film 9 (or optical compensation films 10-15) of Example 9 (or Examples 10-15) shows the curve of gentler slope (downward-sloping) and of closer to the curve of the TN-mode liquid crystal cell (referential data), compared with optical compensation film 1 of Example 1. Or in other words, from the results shown in FIG. 1, it can be understood that Re of optical compensation film 9 (or optical compensation films 10-15) of Example 9 (or Examples 10-15) shows wavelength dispersion of Re more similar to wavelength dispersion of Δn·d of the TN-mode liquid crystal cell, compared with optical compensation film 1 of Example 1, and that, therefore, optical compensation film 9 (or optical compensation films 10-15) of Example 9 (or Examples 10-15) can optically compensate Δn·d of the TN-mode liquid crystal cell in the more precise manner, compared with optical compensation film 1 of Example 1.

Accordingly, it can be understood that, for preparing an optically anisotropic layer of which wavelength dispersion of intrinsic birefringence is relatively flat, or in other words of which wavelength dispersion of intrinsic birefringence is closer to that of birefringence of a general TN-mode liquid crystal cell, using a liquid crystal compound having a structure such as discotic liquid crystal compound-2, good adhesiveness is obtainable.

### Example 16

### <Evaluation as Mounted on TN Mode Liquid Crystal Display Device>

### (Production of Elliptic Polarizing Plate)

The polarizer film was produced by allowing iodine to adsorb on the stretched polyvinyl alcohol film. Next, each of the optical compensation films produced in Examples 1, 3, 4, 8 and 9 was bonded on the support side thereof to one side of the polarizer film, using a polyvinyl alcohol-base adhesive. The optical compensation film was disposed so that the slow axis of the optically anisotropic layer aligns in parallel with the transmission axis of the polarizer film.

A commercially available cellulose triacetate film (Fujitac TD80UF, from FUJIFILM Corporation) was saponified similarly to as described in the above, and bonded to the opposite side of the polarizer film (on the side having no optical film bonded) using a polyvinyl alcohol-base adhesive. The elliptic polarizing plate was produced in this way.

### (Production of TN Mode Liquid Crystal Display Device)

A pair of polarizing plates (an upper polarizing plate and a lower polarizing plate), provided to a 20-inch liquid crystal display device (from SHARP Corporation) employing a TN-mode liquid crystal cell, were peeled off, and instead each of the polarizing plates produced in the above was placed one by one on the observer's side and the backlight side using a pressure sensitive adhesive, so as to oppose the optical compensation film with the liquid crystal cell. The polarizing plates herein were disposed so as to align the transmission axis of the polarizing plate on the observer's side (upper polarizing plate) normal to the transmission axis of the polarizing plate on the backlight side (lower polarizing plate).

### (Evaluation of Liquid Crystal Display Device)

Viewing angle dependence of contrast of thus-produced liquid crystal display devices was evaluated. More specifically, the liquid crystal display devices were allowed to stand in a room conditioned at normal temperature and normal moisture (25° C., 60% RH) for one week, then hue and contrast ratio (transmittance in the white state/transmittance in the black state) were measured at 8 steps ranging from the black state (L1) to the white state (L8) using a measuring instrument (EZ-Contrast 160D, from ELDIM). Contrast is a value calculated based on the contrast ratio (transmittance in the white state/transmittance in the black state). Range of polar angle ensuring a contrast of 10 or larger and not causative of inversion of gradation in the black state was measured, and evaluated according to the criteria below.

Viewing-angle evaluation regarding liquid crystal display devices employing optical compensation films of Examples 10-15 respectively was similar to viewing-angle evaluation of liquid crystal display device employing the optical compensation film of Example 9. Results are shown in Table 5.

### (Evaluation Standards)

[Evaluation Standards regarding Viewing Angle Dependence of Contrast (Range of Polar Angle Ensuring a Contrast of 10 or Larger and not Causative of Inversion of Gradation in the Black State)]
⊚ Polar angle is 80° or larger in all of the upper, lower, left and right directions;
∘ Polar angle is 80° or larger in only three directions of upper, lower, left and right directions;
× Polar angle is 80° or larger in only two directions of upper, lower, left and right directions.

### Example 17

### <Evaluation as Mounted on OCB Mode Liquid Crystal Display Device>

### (Production of Elliptic Polarizing Plate)

The polarizer film was produced by allowing iodine to adsorb on the stretched polyvinyl alcohol film. Next, the optical compensation film produced in Example 2 was bonded on the support side thereof to one side of the polarizer film, using a polyvinyl alcohol-base adhesive. The optical compensation film was disposed so that the longitudinal direction thereof was parallel to the absorption axis of the polarizer film.

A commercially available cellulose triacetate film (Fujitac TD80UF, from FUJIFILM Corporation) was saponified similarly to as described in the above, and bonded to the opposite side of the polarizer film (on the side having no optical film bonded) using a polyvinyl alcohol-base adhesive. The elliptic polarizing plate was produced in this way.

### (Production of OCB Mode Liquid Crystal Cell)

A polyimide film was provided as an alignment layer to each glass substrate having an ITO electrode preliminarily formed thereon, and the alignment layer was then rubbed. Two thus-obtained glass substrates were opposed so that the individual directions of rubbing were parallel to each other, while adjusting thickness of the liquid crystal cell to 7.2 μm. A liquid crystalline compound (ZLI1132, from MERCK) having Δn of 0.1396 was injected into a gap of the liquid crystal cell, to thereby produce a bend-aligned OCB mode liquid crystal cell.

### (Production of Liquid Crystal Display Device)

The bend-aligned liquid crystal cell and the pair of polarizing plates were combined to produce a liquid crystal display device. The polarizing plates were respectively bonded to the observer's side transparent substrate and to the backlight side transparent substrate of the produced bend-aligned liquid crystal cell respectively.

The pair of polarizing plates were disposed relative to the bend-aligned liquid crystal cell, so that each of the optically anisotropic layers was disposed on each of the substrates of the bend-aligned liquid crystal cell, and so that the direction of rubbing of the bend-aligned liquid crystal cell was antiparallel to the direction of rubbing of the optically anisotropic layer disposed thereon.

A liquid crystal display device having a 20-inch, bend-aligned liquid crystal cell was produced in this way.

### <Evaluation of Liquid Crystal Display Device>

The OCB mode liquid crystal display device produced in the above was evaluated in the same manner as described in Example 16. Results are shown in Table 5.

In Table 5,“blank” means a liquid crystal display device produced using polarizing plates without making use of the optical compensation films produced in Examples.

TABLE 5

| | | | Example 16 | | | | | | Example 17 | |
|---|---|---|---|---|---|---|---|---|---|---|
| | Sample | | Example 1 | Example 3 | Example 4 | Example 8 | Example 9 | Blank | Example 2 | Blank |
| Optically | Support | Material | Arton | Arton | Arton | Zeonor | Zeonor | — | Appear | — |
| anisotropic | | | | | | | | | 3000 | |
| film | | Thickness | 80 | 80 | 90 | 95 | 95 | — | 80 | — |
| | | (μm) | | | | | | | | |
| | | Re (nm) | 80 | 80 | 0.7 | 80 | 80 | — | 30 | — |
| | | Rth (nm) | 60 | 60 | 41 | 60 | 60 | — | 330 | — |
| | Optically | Material | DLC-1 *1 | DLC-1 *1 | RLC-1 *2 | DLC-1 *1 | D-112 *3 | — | DLC-1 *1 | — |
| | anisotropic | Thickness | 1.4 | 1.4 | 1.2 | 1.4 | 1.1 | — | 1.4 | — |
| | layer | (μm) | | | | | | | | |
| | | Re (nm) | 30 | 30 | 30 | 30 | 30 | — | 30 | — |
| | | Rth (nm) | 90 | 90 | −80 | 90 | 90 | — | 90 | — |
| Liquid | Mode | | TN | TN | TN | TN | TN | TN | OCB | OCB |
| crystal | Viewing angle | | ⊚ | ⊚ | ∘ | ⊚ | ⊚ | x | ⊚ | x |
| display | dependence | | | | | | | | | |
| device | of contrast | | | | | | | | | |

*1: DLC-1 is discotic liquid crystal compound-1 described above.
*2: RLC-1 is polymerizable rod-like liquid crystal compound described above.
*3: D-112 is a discotic liquid crystal compound described in JPA No. 2006-76992.

From the results shown in Table 5, it can be understood that the TN mode liquid crystal display devices and the OCB mode liquid crystal display device applied with the optical compensation films of Examples of the present invention (in particular, the TN mode applied with the optical compensation films of Examples 1, 3 and 8,and 9-15 and the OCB mode applied with the optical compensation film of Example 2), are remarkably improved in the viewing angle dependence of contrast. It was also found that the TN mode liquid crystal display devices were further improved in hue and contrast in the normal line direction, when optical compensation films of Example 9-15 were applied thereto.

1. An optical compensation film comprising a support, an alignment layer, and an optically anisotropic layer formed of a liquid crystal composition in this order, said support being a cyclic polyolefin polymer film comprising, as a major ingredient, at least one cyclic polyolefin comprising a repeating unit having a cycloaliphatic ring, and having a surface thereof subjected to corona discharge treatment or atmospheric pressure plasma treatment,
wherein said alignment layer is disposed in contact with said treated surface of said support, said liquid crystal composition comprises a radical polymerization initiator capable of generating a halogen radical or a hydrocarbon radical having atoms other than hydrogen atom of the number equal to or smaller than 8, and said optically anisotropic layer is a layer formed by curing said liquid crystal composition on said alignment layer via polymerization.

2. The optical compensation film of claim 1, wherein swellability of said alignment layer is 1 to 2,
where the swellability represents a ratio of thickness of the swelled alignment layer to thickness of the unswelled alignment layer, the swelled and unswelled thicknesses of the alignment layer correspond to thicknesses of the alignment layer after and before the optical compensation film is immersed in a solvent, which is contained as a major solvent in a coating liquid used for preparing the alignment layer.

3. The optical compensation film of claim 1, wherein said alignment layer is formed by curing a curable composition applied to said treated surface of said support under irradiation with light and heat.

4. The optical compensation film of claim 1, wherein said cyclic polyolefin polymer film comprises, as a major ingredient, at least one cyclic polyolefin comprising a repeating unit having a cycloaliphatic ring having at least one substituent containing a hetero atom.

5. The optical compensation film of claim 1, wherein said radical polymerization initiator comprises at least one compound represented by formula (1) below: 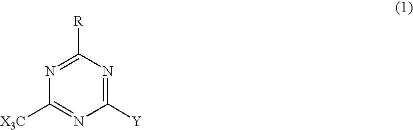
where, X represents a halogen atom; Y represents —CX₃, —NH₂, —NHR′, —NR′₂ or OR′; R′ represents an alkyl group or aryl group; and R represents —CX₃, alkyl group, substituted alkyl group, aryl group, substituted aryl group, or substituted alkenyl group.

6. The optical compensation film of claim 1, wherein the liquid crystal composition comprises at least one discotic liquid crystal compound.

7. The optical compensation film of claim 1, wherein the liquid crystal composition comprises at least one rod-like liquid crystal compound.

8. A polarizing plate comprising a polarizing film and an optical compensation film as set forth in claim 1.

9. A liquid crystal display device comprising at least one polarizing plate as set forth in claim 8.

10. The liquid crystal display device of claim 9, employing a TN-mode or an OCB-mode.

11. A method of producing an optical compensation film comprising a support composed of a cyclic polyolefin polymer film, and an alignment layer and an optically anisotropic layer formed of a liquid crystal composition in this order, comprising in a following order:
(1) subjecting a surface of a cyclic polyolefin polymer film comprising, as a major ingredient, at least one cyclic polyolefin comprising a repeating unit having a cycloaliphatic ring, to corona discharge treatment or atmospheric pressure plasma treatment;
(2) forming an alignment layer on the treated surface of said cyclic polyolefin polymer film treated by corona discharge treatment or atmospheric pressure plasma treatment; and
(3) forming an optically anisotropic layer on said alignment layer by curing a liquid crystal composition, comprising a radical polymerization initiator capable of generating a halogen radical or a hydrocarbon radical having atoms other than hydrogen atom of the number equal to or smaller than 8 via polymerization.

12. The method of claim 11, wherein said step (2) is a step of forming an alignment layer by curing a curable composition applied to the surface of said cyclic polyolefin polymer film, of which surface is subjected to corona discharge treatment or atmospheric pressure plasma treatment, under irradiation with light and heat.

13. The method of claim 11, further comprising, prior to said step (2), removing dust from the treated surface of said cyclic polyolefin polymer film treated by corona discharge treatment or atmospheric pressure plasma treatment.

14. The method of claim 11, further comprising, prior to said step (3), removing dust from a rubbed surface of said alignment layer.

15. The method of claim 13, wherein dust is removed using ultrasonic wave.

16. The method of claim 14, wherein dust is removed using ultrasonic wave.
